(19) United States
(12) Patent Application Publication
(10) Pub. No.: US 2005/0286074 A1
(43) Pub. Date: Dec. 29, 2005

(54) Image transmission system, transmission apparatus, relay apparatus, and image transmission method

(75) Inventors: Tomoyuki Atsumi, Toyohashi-shi (JP); Hiroyasu Ito, Okazaki-shi (JP); Tatsuro Asano, Toyokawa-shi (JP); Hiroaki Sugimoto, Nagoya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/967,357

(22) Filed: Oct. 19, 2004

(30) Foreign Application Priority Data
Jun. 28, 2004 (JP) 2004-189927

(51) Int. Cl. G06F 15/00

(52) U.S. Cl. 358/1.15

(57) ABSTRACT

The present invention provides an image transmission system that comprises a transmission apparatus, and a relay apparatus that receives image information from the transmission apparatus and forwards the received image information to a reception apparatus, wherein the transmission apparatus receives a designation of a time limit by which the image information should arrive at the reception apparatus and transmits time limit information that indicates the time limit to the relay apparatus; the relay apparatus determines a forwarding time period during which the image information is to be forwarded to the reception apparatus, based on the time limit information as well as charge information that indicates, for each of time periods, a charge for forwarding the image information to the reception apparatus, and forwards the image information to the reception apparatus during the determined forwarding period.

This application is based on the application No. 2004-189927 filed in Japan, the content of which is hereby incorporated by reference.

### BACKGROUND OF THE INVENTION

1. Field of the Invention

The present invention relates to image transmission systems, transmission apparatuses, relay apparatuses, and image transmission methods.

2. Description of the Related Art

Recently, Internet facsimile machines (hereafter, referred to as Internet FAX machines) having both a facsimile transmission/reception function and an electronic mail transmission/reception function have become popular. Some Internet FAX machines have an onramp function and an offramp function. The onramp function is capability of receiving image information transmitted as a FAX transmission from a facsimile machine (hereafter, referred to as a FAX machine) over a public telephone network and then putting the received image information into an electronic mail (hereafter, referred to as an e-mail) and forwarding it to a terminal via the Internet. The offramp function, on the other hand, is capability of receiving image information contained in an e-mail transmitted from a terminal via the Internet and then forwarding, as a FAX transmission, the image information to a FAX machine over the public telephone network. Hereinafter, an Internet FAX machine having the onramp function is referred to as an “on ramp”, and an Internet FAX machine having the offramp function is referred to as an “offramp”.

When an onramp and an offramp are employed as relay apparatuses for transmitting image information from a FAX machine (sending end) to another FAX machine (receiving end) at a remote location, there is an advantageous effect that the communication charge can be reduced. This is because the image information is sequentially forwarded from the sending end to the onramp, to the offramp, and then to the receiving end. That is to say, the transmission between the onramp and the offramp is carried out via the Internet, which is available under a flat-rate pricing regardless of the distance therebetween, while the transmissions over the public telephone network, which is normally available under a metered-rate pricing based on the distance, are carried out over short distances between the sending end and the onramp as well as between the offramp and the final destination (the receiving end).

In addition, generally speaking, it is often the case with transmissions via the public telephone network that the communication charges vary depending on during which time period the transmission is made; therefore, by transmitting image information during an inexpensive time period, it is possible to further reduce the communication charge. For instance, the Unexamined Japanese Patent Application Publication No. 2000-57070 discloses a technique with which the user at a sending end is able to specify a time at which image information should be forwarded from an offramp to the final destination.

With this technique, it is not possible to reduce the communication charge unless the user at the sending end knows, in advance, the time periods during which the communication charge for the transmission between the offramp at a remote location and the final destination is relatively more inexpensive.

However, when an example is considered where the sending end is located in a city in Japan, and the offramp is located in a city in a foreign country, it is extremely trouble some for the user in Japan to obtain information about telephone charges in foreign countries. It is not unusual that there are some areas in which more than one services by more than one telephone companies are offered. Thus, it is difficult for the user at the sending end to obtain accurate information about communication charges in foreign countries.

Moreover, it is troublesome for the user at the sending end to have to perform input operations in consideration of the communication charges, in order to have transmission made during an inexpensive time period.

### SUMMARY OF THE INVENTION

An object of the present invention is to provide an image transmission system, a relay apparatus, a transmission apparatus, and an image transmission method, which are each able to save the user at the sending end troublesome operations and enable the user to reduce the communication charge.

The aforementioned object is achieved by an image transmission system comprising a transmission apparatus and a relay apparatus that receives image information from the transmission apparatus and forwards the image information to a reception apparatus, wherein the transmission apparatus includes: a receiving unit operable to receive a designation of a time limit by which the image information should arrive at the reception apparatus; and a transmitting unit operable to transmit time limit information that indicates the time limit to the relay apparatus, and the relay apparatus includes: a reception unit operable to receive the time limit information transmitted from the transmitting unit; a charge information storing unit that stores therein charge information indicating, for each of a plurality of time periods, a charge for forwarding the image information to the reception apparatus; a determining unit operable to determine a forwarding time period during which the image information is to be forwarded to the reception apparatus, based on the time limit information and the charge information; and a forwarding unit operable to forward the image information to the reception apparatus during the determined forwarding period.

With this arrangement, since it is possible to forward the image information during a time period that is before the time limit and has an inexpensive communication charge, there is an advantageous effect for the user on the transmission apparatus end that all the user has to do is to specify the time limit without considering the communication charges, and the user is saved from troublesome operations and is able to reduce the communication charge.

The present invention further provides a relay apparatus that receives image information from a transmission apparatus and forwards the received image information to a reception apparatus, the relay apparatus comprising: a reception unit operable to receive, from the transmission apparatus, time limit information that indicates a time limit by which the image information should arrive at the reception apparatus; a charge information storing unit that stores therein charge information indicating, for each of a plurality of time periods, a charge for forwarding the image information to the reception apparatus; a determining unit operable to determine a forwarding time period during which the image information is to be forwarded to the reception apparatus, based on the time limit information and the charge information; and a forwarding unit operable to forward the image information to the reception apparatus during the determined forwarding period.

With this arrangement, since it is possible to forward the image information during a time period that is before the time limit and has an inexpensive communication charge, there is an advantageous effect for the user on the transmission apparatus end that all the user has to do is to specify the time limit without considering the communication charges, and the user is saved from troublesome operations and is able to reduce the communication charge.

The present invention further provides a transmission apparatus included in an image transmission system in which image information is transmitted from the transmission apparatus to a reception apparatus via a relay apparatus, the transmission apparatus comprising: a receiving unit operable to receive a designation of a time limit by which the image information should arrive at the reception apparatus; and a transmitting unit operable to transmit time limit information that indicates the time limit to the relay apparatus.

With this arrangement, since it is possible that the image information is forwarded from the relay apparatus to the reception apparatus during a time period that is before the time limit and has an inexpensive communication charge, there is an advantageous effect for the user on the transmission apparatus end that all the user has to do is to specify the time limit without considering the communication charges, and the user is saved from troublesome operations and is able to reduce the communication charge.

The present invention further provides a transmission apparatus that transmits image information to a reception apparatus, the transmission apparatus comprising: a receiving unit operable to receive a designation of a time limit by which the image information should arrive at the reception apparatus; a charge information storing unit that stores therein charge information indicating, for each of a plurality of time periods, a charge for transmitting the image information; a determining unit operable to determine a time period during which the image information is to be transmitted, based on the time limit and the charge information; and a transmitting unit operable to transmit the image information during the determined time period.

With this arrangement, since it is possible to transmit the image information during a time period that is before the time limit and has an inexpensive communication charge, there is an advantageous effect for the user on the transmission apparatus end that all the user has to do is to specify the time limit without considering the communication charges, and the user is saved from troublesome operations and is able to reduce the communication charge.

### BRIEF DESCRIPTION OF THE DRAWINGS

These and other objects, advantages and features of the invention will be come apparent from the following description thereof taken in conjunction with the accompanying drawings which illustrate a specific embodiment of the invention.

In the drawings:

FIG. 1 is illustrates one example of the structure of a FAX communication system presented as an example of the image transmission system;

FIG. 2 is a block diagram that shows the structure of a FAX machine included in the FAX communication system;

FIG. 3 illustrates the structure of the operation panel of the FAX machine;

FIG. 4 shows the structure of a charge information table stored in the FAX machine;

FIG. 5 shows the structure of an MFP included in the FAX communication system;

FIG. 6 illustrates the structure of the operation panel of the MFP;

FIG. 7 shows the structure of an offramp information table stored in the MFP;

FIG. 8 is a block diagram that shows the structure of another MFP included in the FAX communication system;

FIG. 9 shows the structure of the operation panel of said another MFP;

FIG. 10 shows the structure of a charge information table stored in said another MFP;

FIG. 11 shows the structure of another charge information table stored in said another MFP;

FIG. 12 shows the structure of another charge information table stored in said another MFP;

FIG. 13 is flowchart illustrating the main routine of the processing performed by a controller of the FAX machine;

FIG. 14 is a flowchart illustrating a subroutine of the input processing performed by the controller;

FIG. 15 is a flowchart illustrating a subroutine of the input processing performed by the controller;

FIG. 16 is a flowchart illustrating a subroutine of the timer processing performed by the controller;

FIG. 17 is a flowchart illustrating a subroutine of the lowest communication charge seeking processing performed by the controller;

FIG. 18 is a flowchart illustrating a subroutine of the scanning processing performed by the controller;

FIG. 19 is a flowchart illustrating a subroutine of the transmission processing performed by the controller;

FIG. 20 is a flowchart illustrating the main routine of the processing performed by the controller of the MFP;

FIG. 21 is a flowchart illustrating a subroutine of the input processing performed by the controller;

FIG. 22 is a flowchart illustrating a subroutine of the FAX reception processing performed by the controller;

FIG. 23 is a flowchart illustrating a subroutine of the e-mail transmission processing performed by the controller;

FIG. 24 is a flowchart illustrating the main routine of the processing performed by the controller of said another MFP;

FIG. 25 is a flowchart illustrating a subroutine of the input processing performed by the controller;

FIG. 26 is a flowchart illustrating a subroutine of the e-mail reception processing performed by the controller; and

FIG. 27 is a flowchart illustrating a subroutine of the timer processing performed by the controller.

### DESCRIPTION OF THE PREFERRED EMBODIMENTS

The following describes an embodiment of an image transmission system, a relay apparatus, and a transmission apparatus of the present invention, with reference to the drawings.

1. The Structure of the Image Transmission System

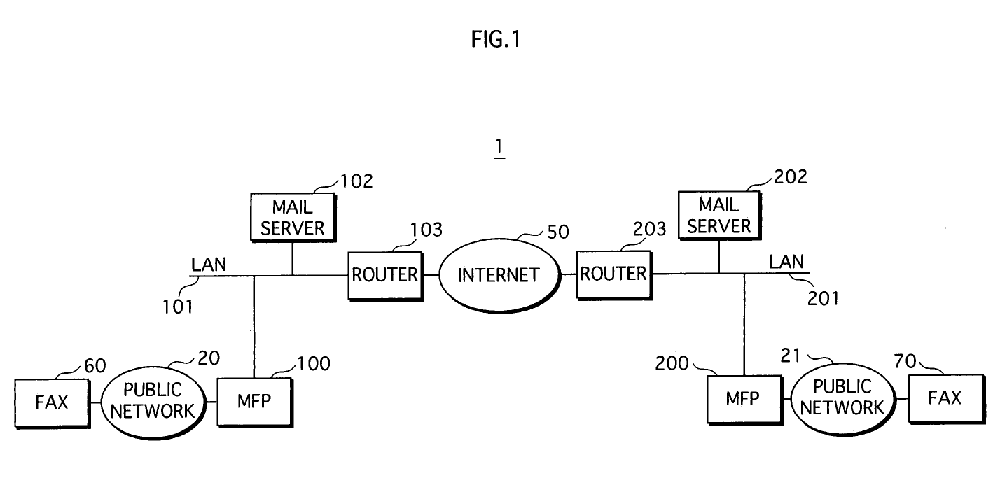

FIG. 1 illustrates one example of the structure of the FAX communication system (hereafter, simply referred to as the system) 1 presented as an example of the image transmission system.

As illustrated in the figure, the system 1 includes FAX machines 60, 70, and multiple function peripherals (hereinafter, referred to as “MFPs”) 100, 200. The MFP 100 is connected with the FAX machine 60, and the MFP 200 is connected with the FAX machine 70, via public telephone networks (hereinafter, referred to as the “public networks”) 20 and 21, respectively. In addition, the MFP 100 is connected with the MFP 200 via LANs (Local Area Networks) 101, 201 and the Internet 50.

The FAX machines 60 and 70 are each capable of FAX transmission/reception over the public networks 20 and 21 using the FAX transmission control procedures for Group 3 (hereinafter, “G3”).

The MFPs 100 and 200 each have a scan function of scanning an image to obtain image information from a document, and a copy function of printing out an image on paper based on scanned image information. Further, the MFPs 100 and 200 are each capable of transmitting and receiving data to and from each other over the LANs 101, 102 and the Internet 50 using, in this embodiment, TCP/IP (Transmission Control Protocol/Internet Protocol), and each have an e-mail transmission/reception function of transmitting and receiving e-mails via mail servers 102 and 202, as well as routers 103 and 203 that are each connected to one of the LANs 101 and 201.

Additionally, the MFP 100 has an onramp function of receiving, as a FAX reception, image information transmitted from a FAX machine serving as a sending end, over the public network, and forwarding the received image information to another machine via the Internet 50 by e-mail.

On the other hand, the MFP 200 has an offramp function of receiving an e-mail transmitted via the Internet 50, and forwarding, as a FAX transmission, the image information contained in the received e-mail to a FAX machine serving as the final destination. Thus, each of the MFPs 100 and 200 acts also as a FAX gateway.

Here, it is assumed as follows: The FAX machines 60 and 70 are located in places being remote from each other. For instance, the FAX machine 60 is located in City A in Japan, and the FAX machine 70 is located in City B in the USA. The MFP 100 is located in the vicinity of City A, and the MFP 200 is located in the vicinity of City B.

It should be noted that although the figure illustrates only the MFP 100 as an onramp and only the MFP 200 as an offramp, it is naturally understood that the numbers of on ramps and off ramps are not limited to this specific example illustrated, needless to say. It is acceptable to have more than one onramp and more than one offramp. Hereinafter, the MFP 100 may also be referred to as “the on ramp”, and the MFP 200 may also be referred to as “the offramp”.

With the structure mentioned above, the processing described below is performed in the system 1, in which the sending end is the FAX machine 60 (a transmission apparatus), the final destination is the FAX machine 70 (a reception apparatus), and image information is transmitted (hereafter, referred to as “transmission by an Internet FAX”) from the sending end to the final destination via the MFP 100, the MFP 200 (relay apparatuses).

(A) The Processing Performed by the Fax Machine 60 Serving as the Sending End

The FAX machine 60 receives an address of the FAX machine 70 serving as the final destination as well as a designation from a user of a time limit by which the image to be transmitted should arrive at the FAX machine 70 (hereafter, referred to as “the arrival time limit”), being expressed as, for example, a local date and time (the Japan Time). The FAX machine 60 then seeks a time period which is before the specified arrival time limit and during which the communication charge for the FAX transmission to the MFP 100 via the public network 20 is the most inexpensive. When the most in expensive time period comes, the FAX machine 60 transmits, as a FAX transmission, the image information to the MFP 100. At that time, the FAX machine 60 transmits the information indicating the final destination (destination information) and the information indicating the arrival time limit (time limit information) to the MFP 100 so as to inform, via the MFP 100, the MFP 200 serving as the offramp of the specified final destination and arrival time limit.

(B) The Processing Performed By The MFP 100 Serving As The Onramp

Having received, as a FAX reception, the image information, the destination information, and the time limit information from the FAX machine 60, the MFP 100 generates an e-mail that contains those kinds of received information and forwards the e-mail to the MFP 200 serving as the offramp.

(C) The Processing Performed by the MFP 200 Serving as the Offramp

Having received the e-mail from the MFP 100, the MFP 200 extracts the image information, the destination information, and the time limit information contained in the e-mail. The MFP 200 then seeks a time period that is before the arrival time limit specified by the sending end and during which the communication charge for the FAX transmission to the FAX machine 70 serving as the final destination according to the destination information via the public network 21 is the most inexpensive. When the most inexpensive time period comes, the MFP 200 calls the FAX machine 70 serving as the final destination and transmits, as a FAX transmission, the image information.

As explained above, in the system 1, as for transmissions by an Internet FAX, the sending end and the offramp transmit the image information when such a time period comes that is before the arrival time limit specified by the user at the sending end and has the most inexpensive communication charge. Accordingly, in order to reduce the communication charge, all the user at the sending end has to do is to specify an arrival time limit, without thinking about communication charges.

The following describes in detail the structures of, and various kinds of processing performed by, the FAX machines 60, 70, and the MFPs 100 and 200.

2. The Structure of Fax Machine 60

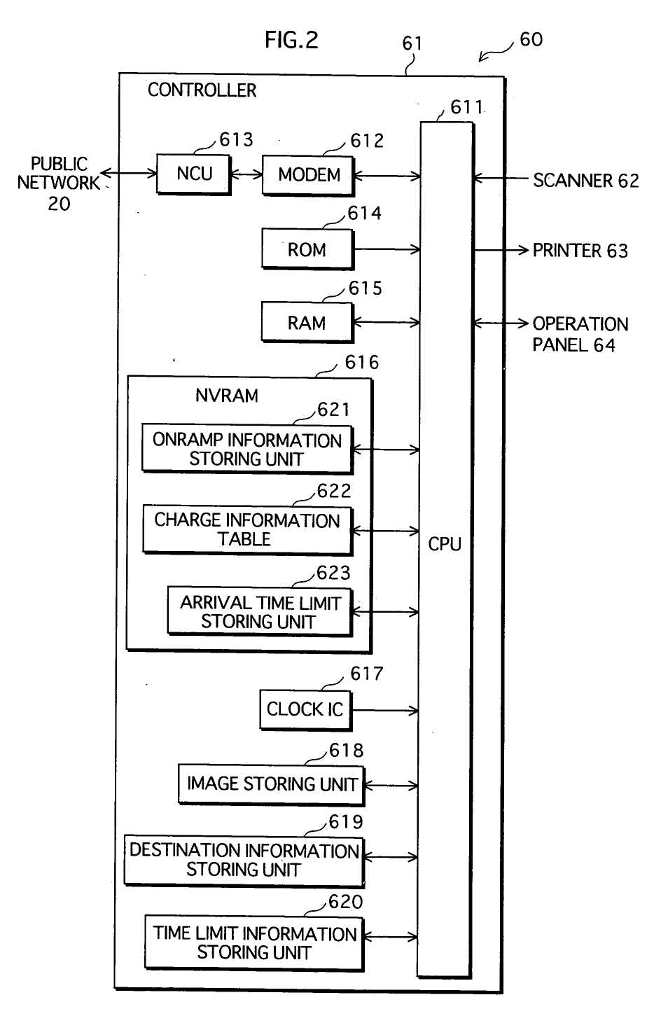

FIG. 2 is a block diagram illustrating the structure of the FAX machine 60.

As illustrated in the figure, the FAX machine 60 includes, as its main components, a controller 61, a scanner 62, a printer 63, and an operation panel 64.

The scanner 62 is a conventional device that scans an image from a document being set to obtain image information in the document.

The printer 63 is a conventional electrophotographic printer that prints out an image on paper based on image information.

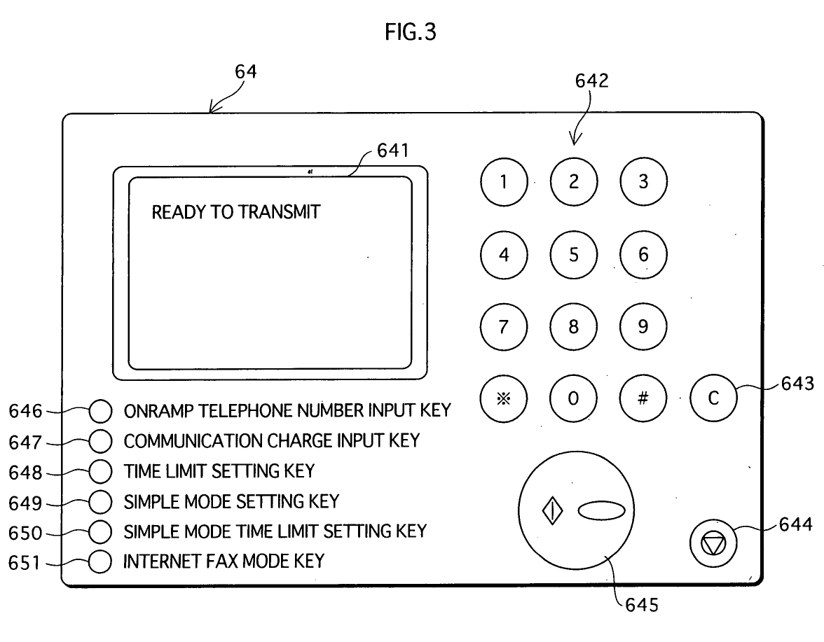

As shown in FIG. 3, the operation panel 64 has a display unit 641, a ten-key pad 642, a clear key 643, a stop key 644, a start key 645, an onramp telephone number input key 646, a communication charge input key 647, a time limit setting key 648, a simple mode setting key 649, a simple mode time limit setting key 650, and an Internet FAX mode key 651.

The ten-key pad 642 is used by the operator to input telephone numbers and other information. The clear key 643 is used to clear (reset) inputted information such as numbers. The stop key 644 is used to stop an operation, for example, of FAX transmission while it is being performed. The start key 645 is used to start operations of, for example, FAX transmission.

The onramp telephone number input key 646 is used to have the FAX machine 60 enter the mode in which the telephone number of an MFP serving as the onramp can be specified.

The communication charge input key 647 is used to have the FAX machine 60 enter the mode in which communication charges for different time periods can be inputted in a case where the charges for the FAX machine 60 to communicate over the public network 20 vary depending on time periods of a day.

The time limit setting key 648 is used to have the FAX machine 60 enter the time limit setting mode in which the arrival time limit (in this case date and time) can be specified in a case where the transmission is performed in the Internet FAX mode.

The simple mode setting key 649 is used to have transmission in the Internet FAX mode performed in the simple mode. Here, the simple mode is a mode in which the arrival time limit is automatically set to be a predetermined time in the next twenty-four hours (the predetermined time will be set in advance, for example 6:00 a. m.). When the operator has pushed the key 649 and the FAX machine 60 enters the simple mode, since the predetermined time is automatically set as the arrival time limit, there is no need for the operator to manually input the arrival time limit. Thus, the operation is simplified as much.

The simple mode time limit setting key 650 is used to have the FAX machine 60 enter the mode in which the predetermined time used as an arrival time limit to be automatically set in the simple mode is inputted.

The Internet FAX mode key 651 is used to have the FAX machine 60 enter the mode (“the Internet FAX mode”) in which transmission is performed by an Internet FAX.

The operator pushes the keys that are necessary and inputs information and expresses designation that are necessary in each mode which the FAX machine has entered.

The display unit 641 is a liquid crystal display (LCD) and displays various kinds of information including a telephone number inputted by the operator, as well as an input receiving screen (not shown in the drawing) for each mode that the FAX machine 60 enters when a key such as the onramp telephone number in put key 646 has been pushed. The display unit 641 also displays an operation state of the FAX machine 60. Since the display unit 641 has a touch panel laminated over the surface thereof, the operator is able to, through touch operations on the display screen, select an appropriate screen to be displayed so that various kinds of information can be inputted and registered on the displayed screen.

With reference back to FIG. 2, the controller 61 includes, as its main components, a CPU 611, a modem 612, an NCU 613, a ROM 614, a RAM 615, an NVRAM 616, a clock IC 617, an image storing unit 618, a destination information storing unit 619, and a time limit information storing unit 620.

The modem 612 modulates and demodulates signals for the FAX transmission control procedure and image signals. The NCU (Network Controller Unit) 613 is connected to the public network 20, and inputs and outputs outgoing calls, incoming calls, analog signals, and the like.

The NVRAM 616 is a non-volatile memory, and includes an onramp information storing unit 621, a charge information table 622, and a time limit storing unit 623.

The onramp information storing unit 621 stores therein telephone number information for the MFP 100 used as the onramp, and the telephone number information is read as the telephone number of the onramp when a FAX transmission is performed.

The charge information table 622 stores therein charge information that indicates communication charges over the public network 20.

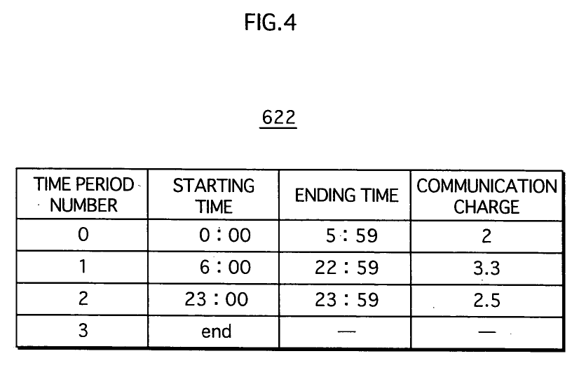

FIG. 4 shows the structure of the charge information table 622.

As shown in the drawing, the charge information table 622 has a time period number column, a starting time column, an ending time column, and a communication charge column.

The time period number column shows the numbers used to identify a plurality of time periods that have mutually different communication charges. In the example illustrated here, the numbers “0” to “3” are used.

The starting time of each time period is written in the starting time column. The ending time of each time period is written in the ending time column.

The communication charge column shows, for each time period, the communication charge over the public network 20 per unit length of time.

These various kinds of information shown in these columns are registered in advance by, for example, a person who manages the FAX machine 60, using the communication charge input key 647 and setting the machine into the communication charge input mode, and are stored in the charge information table 622. In this respect, the charge information table 622 serves as a charge information storing unit that stores therein charge information indicating a charge for each time period for transmitting image information.

It should be noted that FIG. 3 illustrates an example in which the public network being used has a communication charge pricing system where the communication charges for a day (24 hours) are divided into substantially three time periods; however, the pricing system may vary depending on the communication network to be used, and the contents of the charge table may also vary depending on the pricing system of the communication network used to make the connections. The same is true with the charge tables 2171 to 2173 for the MFP 200, to be described later.

With reference back to FIG. 2, the time limit storing unit 623 stores therein an arrival time limit in the simple mode. This arrival time limit is set in advance while the machine is in the mode in which an arrival time limit can be set in the simple mode using the simple mode time limit setting key 650 and stored in the time limit storing unit 623.

The ROM 614 stores therein control programs of the FAX machine 60.

The CPU 611 reads an appropriate control program from the ROM 614 as necessary, and controls overall operations of FAX transmission/reception. The details of this controlling operation will be described later.

The CPU 611 also receives information regarding key inputs made on the operation panel 64, judges which key has been pushed by the operator, and controls the display unit 641 so as to have a menu screen and the like for each mode displayed.

The RAM 615 is used as a work area when the CPU 611 executes the control programs.

The clock IC 617 is a conventional IC that counts time to indicate a current time. Electric power is constantly supplied to the clock IC 617 from a backup battery, which is not shown in the drawing. The clock IC 617 informs the CPU 611 of the current time.

The image storing unit 618 stores therein image information which has been read from a document by the scanner 62, image information that has been transmitted from an external FAX machine, and so on. The stored image information such as these examples is read by the CPU 611, as necessary, when the image information is to be transmitted to an external machine or outputted as a print-out.

The destination information storing unit 619 stores therein a destination telephone number of a FAX machine which is to be specified as the final destination by the operator when transmission is performed by an Internet FAX.

The time limit information storing unit 620 stores therein an arrival time limit which has been set while the machine is in the time limit setting mode. The destination information and the time limit information are read by the CPU 611 and transmitted along with the image information, when transmission is performed by an Internet FAX.

It should be noted that the FAX machine 70 is substantially identical in terms of the structures to the FAX machine 60, and thus description thereof is omitted.

3. The Structure of the MFP 100

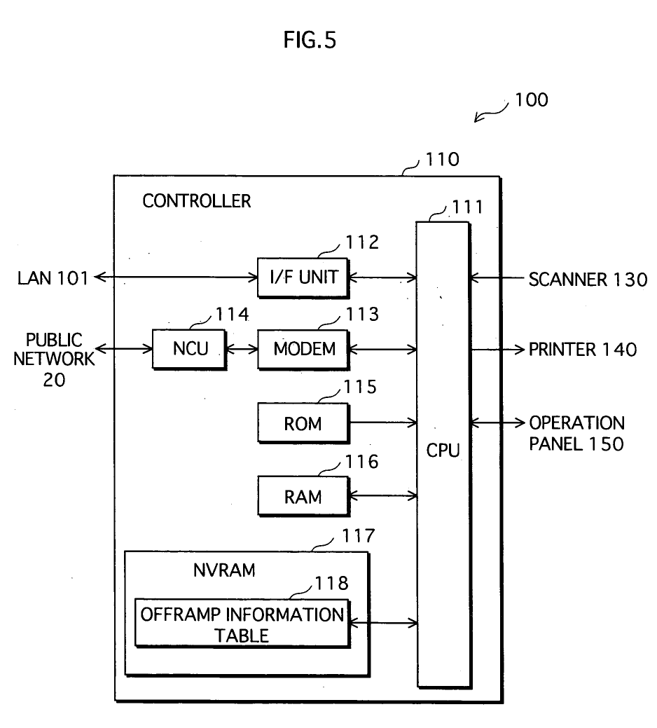

FIG. 5 is a block diagram illustrating the structure of the MFP 100.

As illustrated in the figure, the MFP 100 includes, as its main components, a controller 110, a scanner 130, a printer 140, and an operation panel 150.

The scanner 130 and the printer 140 are substantially identical in terms of the structures to the scanner 62 and the printer 63 described above, respectively.

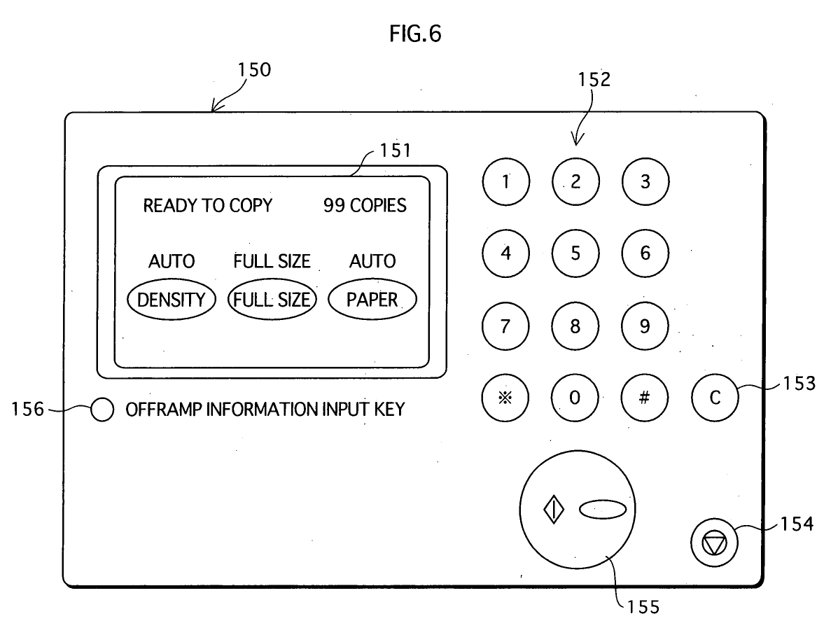

As illustrated in FIG. 6, the operation panel 150 has a display unit 151, a ten-key pad 152, a clear key 153, a stop key 154, a start key 155, and an offramp information input key 156.

The ten-key pad 152 is used by the operator to input the number of copies to be made, a telephone number, and other information. The clear key 153 is used to clear (reset) inputted information such as the number of copies to be made. The stop key 154 is used to stop an operation, for example, of copying while it is being performed. The start key 155 is used to start operations of copying, FAX transmission, or the like.

The offramp information input key 156 is used to have the MFP 100 enter the off ramp information input mode. The offramp information input mode is for receiving an input of offramp information (in this example, the telephone number and the domain name of the onramp) from the operator. In the input receiving mode such as this, the operator is able to input offramp information.

The display unit 151 is an LCD and displays various kinds of information including the number of copies to be made and a telephone number inputted by the operator, as well as an input receiving screen for each mode that the MFP 100 enters, such as the offramp information input mode. The display unit 151 also displays an operation state of the MFP 100. Since the display unit 151 has a touch panel laminated over the surface thereof, the operator is able to, through touch operations on the display screen, input and register various kinds of information.

With reference back to FIG. 5, the controller 110 has a CPU 111, an I/F unit 112, a modem 113, an NCU 114, a ROM 115, a RAM 116, and an NVRAM 117.

The I/F unit 112 is an interface for establishing connection with the LAN 101 such as a LAN card or a LAN board.

The modem 113 and the NCU 114 are identical in terms of the functionality to the modem 612 and the NCU 613 described above, respectively.

The ROM 115 stores therein control programs of the MFP 100.

The CPU 111 reads an appropriate control program from the ROM 115 as necessary, and controls operations of scanning, copying, and operations performed as an onramp. To be more specific, for scanning, the CPU 111 instructs the scanner 130 to scan an image from a document. For copying, the CPU 111 forwards image information obtained as a result of scanning performed by the scanner 130 to the printer 140, and instructs the printer 140 to print out the image information as an image. The operations of the MFP 100 serving as an on ramp will be described later.

The CPU 111 also receives information regarding key inputs made on the operation panel 150, judges which key has been pushed by the operator, and controls the display unit 151 so as to have a menu screen and the like for each mode displayed.

The RAM 116 is used as a work area when the CPU 111 executes the control programs. The RAM 116 also temporarily stores therein the image information, destination information, and time limit information that have been transmitted from the sending end.

The NVRAM 117 is a non-volatile memory, and includes an offramp information table 118.

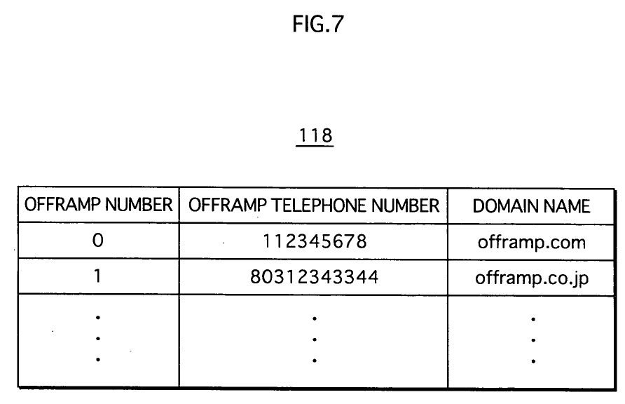

FIG. 7 illustrates the structure of the offramp information table 118.

As illustrated in the figure, the offramp information table 118 has an offramp number column, a telephone number column, and a domain name column.

Offramp numbers, such as 1, 2, and so on, for identifying offramps are shown in the offramp number column.

The telephone number of a machine to be used as an offramp is shown in the telephone number column. The domain name of such a machine is shown in the domain name column. (As an alternative to the domain name, any information such as an IP address may be used as long as it corresponds to an address used on a communication network such as the Internet or the LAN.)

These various kinds of information shown in these columns are registered in advance by, for example, a person who manages the MFP 100, using the offramp information input key 156 and setting the MFP 100 into the offramp information input mode, and are stored in the offramp information table 118. In the example illustrated in the drawing, the offramp identified with the offramp “0” denotes the MFP 200.

4. The Structure of the MFP 200

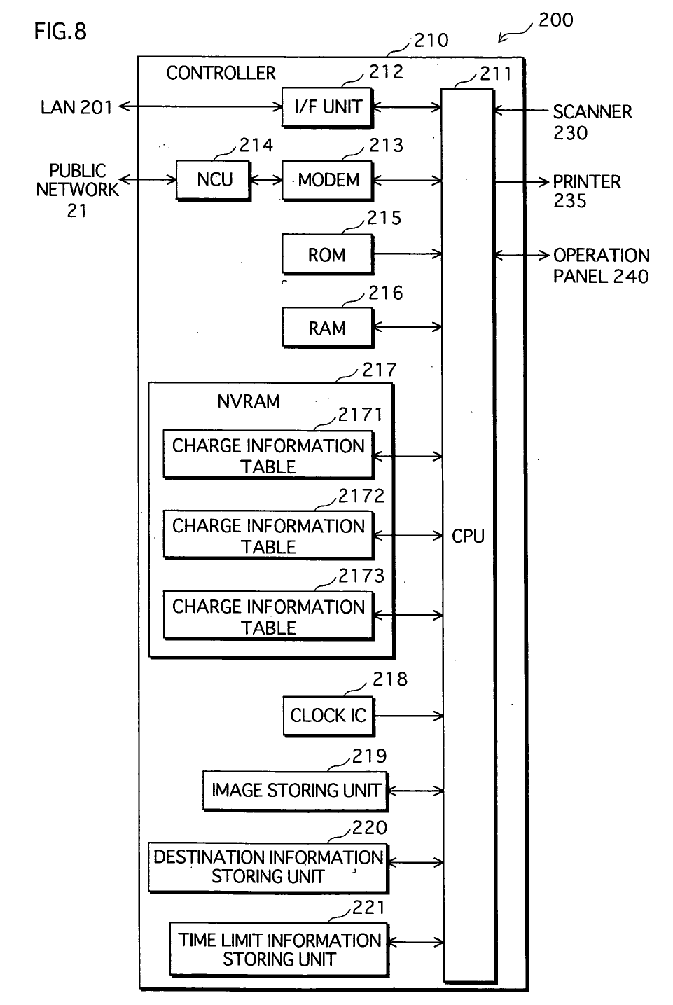

FIG. 8 is a block diagram illustrating the structure of the MFP 200.

As shown in the figure, the MFP 200 includes, as its main components, a controller 210, a scanner 230, a printer 235, and an operation panel 240.

The scanner 230 and the printer 235 are substantially identical to the scanner 62 and the printer 63 described above, respectively.

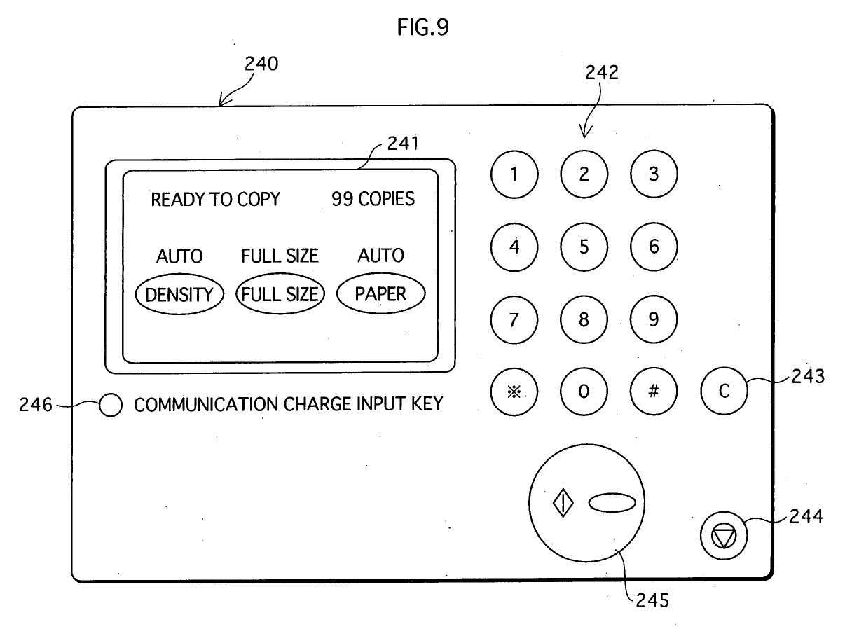

As illustrated in FIG. 9, the operation panel 240 has a display unit 241, a ten-key pad 242, a clear key 243, a stop key 244, a start key 245, and a communication charge input key 246. The keys except for the communication charge input key 246 are each identical in terms of the functionality to the keys with the same names, respectively, included in the operation panel 150 of the MFP 100.

The communication charge input key 246 is used to have the MFP 200 enter the mode in which communication charges for different time periods can be inputted in a case where the charges for the MFP 200 to communicate over the public network 21 vary depending on time periods of a day. The communication charge input key 246 is identical in terms of the functionality to the communication charge input key 647 described above. In this mode, the operator is able to input the communication charges for each of different time periods.

With reference back to FIG. 8, the controller 210 includes, as its main components, a CPU 211, an I/F unit 212, a modem 213, an NCU 214, a ROM 215, a RAM 216, an NVRAM 217, a clock IC 218, an image storing unit 219, a destination information storing unit 220, and a time limit information storing unit 221.

The I/F unit 212, the modem 213, the NCU 214, and the clock IC 218 are substantially identical in terms of the functionality to corresponding components described above, namely the I/F unit 112, the modem 113, the NCU 114 included in the MFP 100, and the clock IC 617 included in the FAX machine 60.

The ROM 215 stores therein control programs of the MFP 200.

The CPU 211 reads an appropriate control program from the ROM 215 as necessary, and controls operations of scanning, copying, and operations performed as an offramp. The operations of scanning and copying are substantially the same as those described regarding the MFP 100. The operations of the MFP 200 serving as an offramp will be described later.

Further, the CPU 211 receives information regarding key inputs made on the operation panel 240, judges which key has been pushed by the operator, and controls the display unit 241 so as to have, for example, an input receiving screen for each mode displayed.

The RAM 216 is used as a work area when the CPU 211 executes the control programs.

The NVRAM 217 is a non-volatile memory, and includes charge information tables 2171, 2172, and 2173.

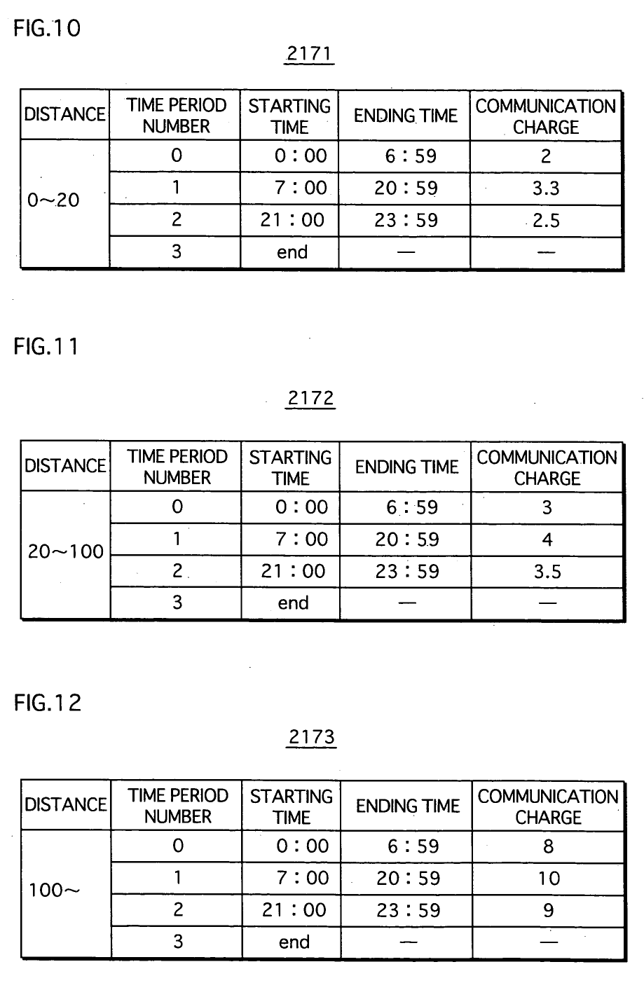

FIG. 10 shows the structure of the charge information table 2171. FIG. 11 shows the structure of the charge information table 2172. FIG. 12 shows the structure of the charge information table 2173.

As shown in the drawing, the charge information tables 2171, 2172, and 2173 each have a distance column, a time period number column, a starting time column, an ending time column, and a communication charge column. Except for the distance column, the items shown in the columns are substantially identical to the ones in the charge information table 622 described above.

The distance column shows, in the case where the communication charges vary depending on not only time periods but also distances, the ranges of distance into which the pricing system is divided. In the example illustrated here, for each of the three distance ranges, a corresponding table is provided, namely the charge information tables 2171, 2172, and 2173. More specifically, the charge information table 2171 is designed to be used when the distance of communication is within a range of less than 20 kilometers. The charge information table 2172 is designed to be used when the distance of communication is within a range of 20 to 100 kilometers. The charge information table 2173 is designed to be used when the distance of communication is within a range of over 100 kilometers.

The various kinds of information shown in the columns of the charge information tables 2171, 2172 and 2173 are registered in advance by, for example, a person who manages the MFP 200, using the communication charge input key 246 and setting the MFP 200 into the communication charge input mode, and are stored in the charge information tables 2171, 2172, and 2173.

In this respect, the charge information tables 2171, 2172, and 2173 each serve as a charge information storing unit that stores therein charge information indicating a charge for each time period for forwarding image information.

The image storing unit 219 stores therein image information which has been read from a document by the scanner 62, image information that has been transmitted from an external machine such as the MFP 100, and so on. The stored image information such as these examples is read by the CPU 211, as necessary, when the image information is to be transmitted to an external machine or outputted as a print-out.

The destination information storing unit 220 stores therein the destination information transmitted from the MFP 100.

The time limit information storing unit 221 stores therein the time limit information transmitted from the MFP 100.

5. The Processing Performed by the Fax Machine 60 Serving as the Sending End

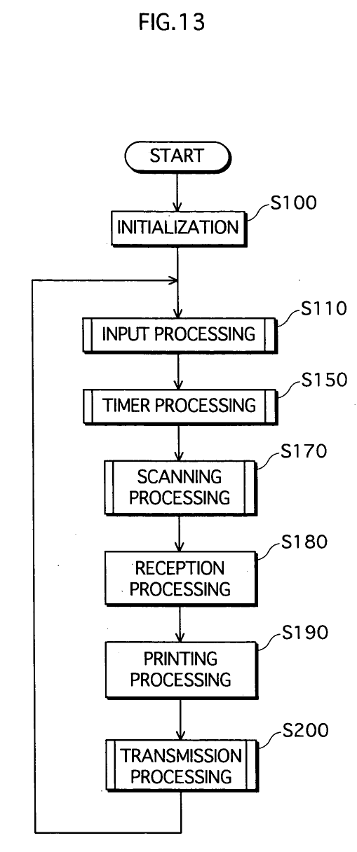

FIG. 13 is a flowchart illustrating the main routine of the processing performed by the controller 61 of the FAX machine 60.

As illustrated in the figure, the controller 61 first performs initialization (step S100). Through the initialization, the RAM 615 is cleared, registers are set, and variables and flags are reset.

After the initialization, input processing (Step S110), timer processing (Step S150), scanning processing (Step S170), reception processing (Step S180), printing processing (Step S190), and transmission processing (Step S200) are sequentially performed.

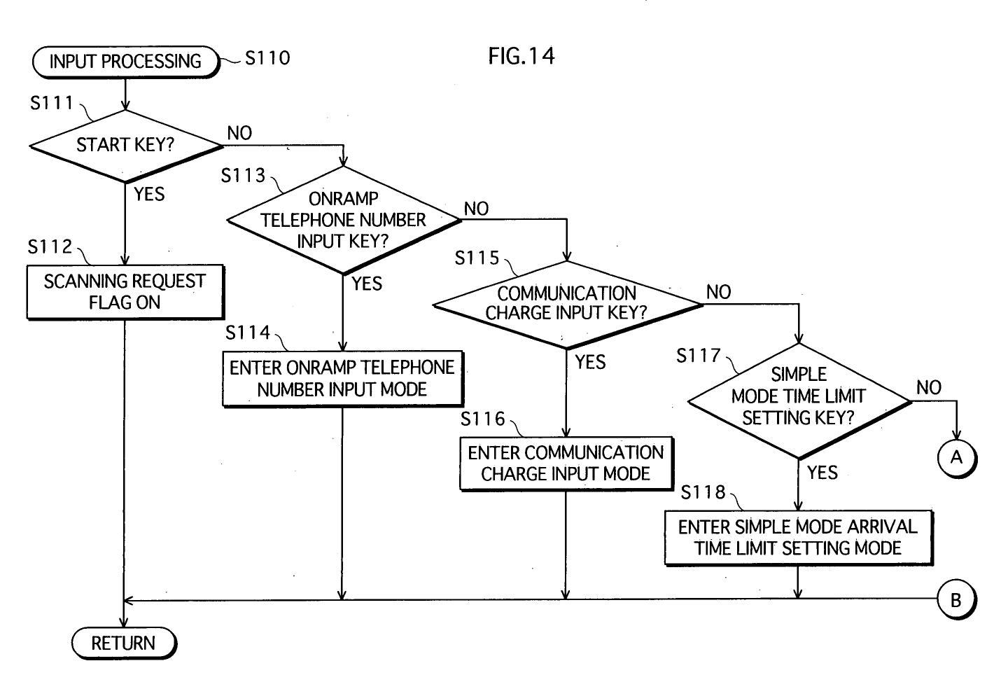

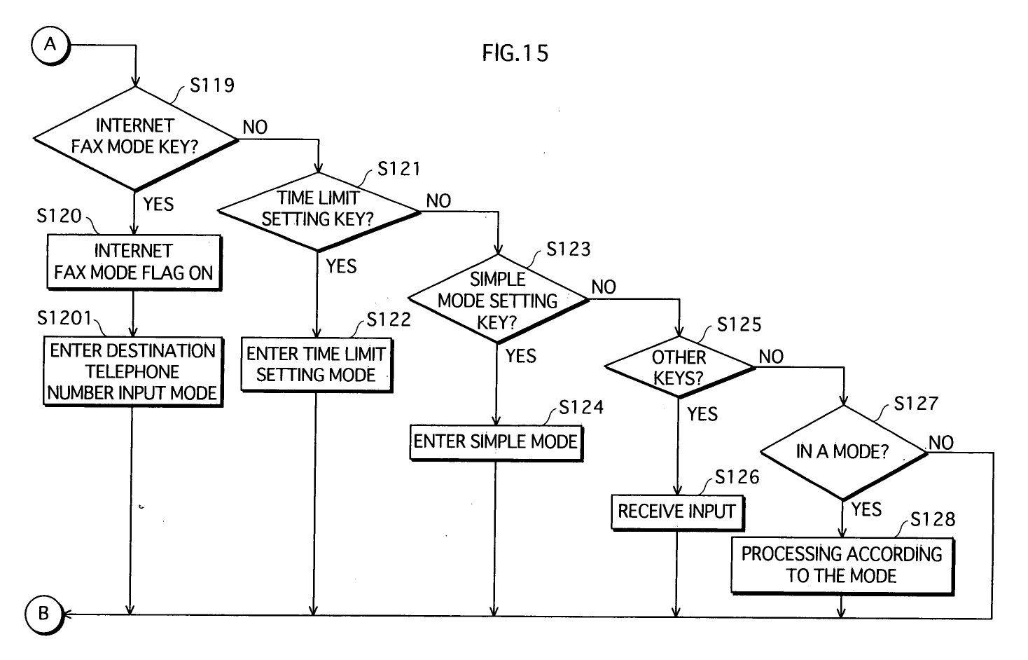

FIGS. 14 and 15 are a flowchart illustrating a subroutine of the input processing. The input processing is to, when a key input has been made on the operation panel 64 by the operator, perform the reception processing of the input.

As shown in FIG. 14, the controller 61 judges whether or not the start key 645 has been pushed (Step S111). Here, when the judgment result is that the start key 645 has been pushed (Step S111: YES), a scanning request flag is turned “ON” (Step S112) and the procedure returns to the main routine.

When the judgment result is that the onramp telephone number input key 646 has been pushed instead of the start key 645 (Step S111: NO; Step S113: YES), the FAX machine 60 enters the onramp telephone number input mode (Step S114), and the procedure returns to the main routine.

When the judgment result is that the communication charge input key 647 has been pushed instead of the onramp telephone number input key 646 (Step S113: NO; Step S115: YES), the FAX machine 60 enters the communication charge input mode (Step S116), and the procedure returns to the main routine.

When the judgment result is that the simple mode time limit setting key 650 has been pushed instead of the communication charge input key 647 (Step S115: NO; Step S117: YES), the FAX machine 60 enters the simple mode time limit setting mode (Step S118), and the procedure returns to the main routine.

With reference to FIG. 15, when the judgment result is that the Internet FAX mode key 651 has been pushed instead of the simple mode time limit setting key 650 (Step S117: NO; Step S119: YES), the Internet FAX mode flag is turned “ON” (Step S120), the FAX machine 60 enters the destination telephone number input mode in which an input of the telephone number for the final destination is received (Step S1201), and the procedure returns to the main routine.

Further, when the judgment result is that the time limit setting key 648 has been pushed instead of the Internet FAX mode 651 (Step S119: NO; Step S121: YES), the FAX machine 60 enters the time limit setting mode (Step S122), and the procedure returns to the main routine.

When the judgment result is that the simple mode setting key 649 has been pushed instead of the time limit setting key 648 (Step S121: NO; Step S123: YES), the FAX machine 60 enters the simple mode (Step S124), and the procedure returns to the main routine. In such a case, transmission in the Internet FAX mode will be performed in the simple mode.

When the judgment result is that any other key besides the ones mentioned above has been pushed (Step S123: NO; Step S125: YES), processing for receiving the key input having been pushed is performed (Step S126), for instance, in a case where some of the keys in the ten-key pad 642 have been pushed, the numbers indicating the pushed keys are displayed by the display unit 641, and the procedure returns to the main routine.

When the judgment result is that no key has been pushed (Step S125: NO), it is judged whether or not the FAX machine 60 is, as a result of the aforementioned Steps S114, S116, and so on, in one of the input modes and the setting modes (Step S127). When the FAX machine 60 is in an input mode or the like (Step S127: YES), the processing of receiving the information inputted by the operator on the input receiving screen in the mode is performed (Step S128), and the procedure returns to the main routine.

More specifically, when the FAX machine 60 is in the onramp telephone number input mode, for example, since the telephone number of a machine to serve as an onramp is inputted by the operator, the information indicating the inputted telephone number is stored into the onramp information storing unit 621. As another example, when the FAX machine 60 is in the communication charge input mode, since communication charges for different time periods are inputted by the operator, the communication charges are stored into the charge information table 622. To be more specific, a screen is displayed which is in a table format and is similar to the charge table 622 shown in FIG. 4 (in which “0”, “1” and so on are displayed in the time period number column) as an input receiving screen, and the inputs from the operator with the use of the ten-key pad 642 and the like are received, for items such as the starting time, the ending time, and the communication charge for each of the time periods. The inputted pieces of data are written into the appropriate sections of the charge information table 622. In the input receiving screen, a complete button (not shown in the drawing) is provided, and when the complete button has pushed, it is judged that the input is completed, and “end” is written into the starting time column of the row identified with a number that follows the time period number of the last time period for which a starting time and the like have been inputted (in the example illustrated in FIG. 4, the row identified with “3”).

In the time limit setting mode in the simple mode, the operator inputs a specific time which is to be set as the arrival time limit in the simple mode. Thus, the information indicating the inputted time is stored into the time limit storing unit 623.

In this respect, the simple mode setting key 648 and the simple mode time limit setting key 650 included in the operation panel 64 together with the controller 61 (while performing the input processing described in Step S118, S124, S128, and so on) serve as a receiving unit that is operable to receive a designation of a time limit by which the image information should arrive at the reception apparatus.

In the destination telephone number input mode, when the operator has inputted the telephone number of a FAX machine serving as the final destination (in the present example, the FAX machine 70) in the case where the transmission is performed by an Internet FAX, the controller 61 has the inputted telephone number stored into the destination information storing unit 619.

When the operator has specified an arrival time limit in the time limit setting mode, the controller 61 has the specified arrival time limit stored into the time limit information storing unit 620.

In this respect, the time limit setting key 648 included in the operation panel 64 together with the controlling unit 61 (while performing the input processing described in Steps S122, S128, or the like) serve as a receiving unit that is operable to receive a designation of a time limit by which the image information should arrive at the reception apparatus.

On the other hand, when the judgment result is that the FAX machine 60 is not in any mode (Step S127: NO), the procedure just returns to the main routine.

When the operator wishes to have a transmission performed in the Internet FAX mode as a job, (i) after pushing the Internet FAX mode key 651, the operator inputs, in the destination telephone number input mode, the telephone number of the FAX machine serving as the final destination, (ii) pushes the time limit setting key 648 and specifies, in the time limit setting mode, a desired arrival time limit, and (iii) sets a document onto the scanner 62 and pushes the start key 645 so as to have the transmission started.

In such a case, if the operator pushes the simple mode setting key 649, the FAX machine 60 enters the simple mode, and the arrival time limit is automatically set as the predetermined time as explained above; therefore, it is also possible to omit the operation of inputting the time limit, described under (ii) above. It should be noted that when the operator wishes to have a normal FAX transmission, the operator inputs a destination telephone number with the use of the ten-key pad 642 and performs the operation described under (iii) above.

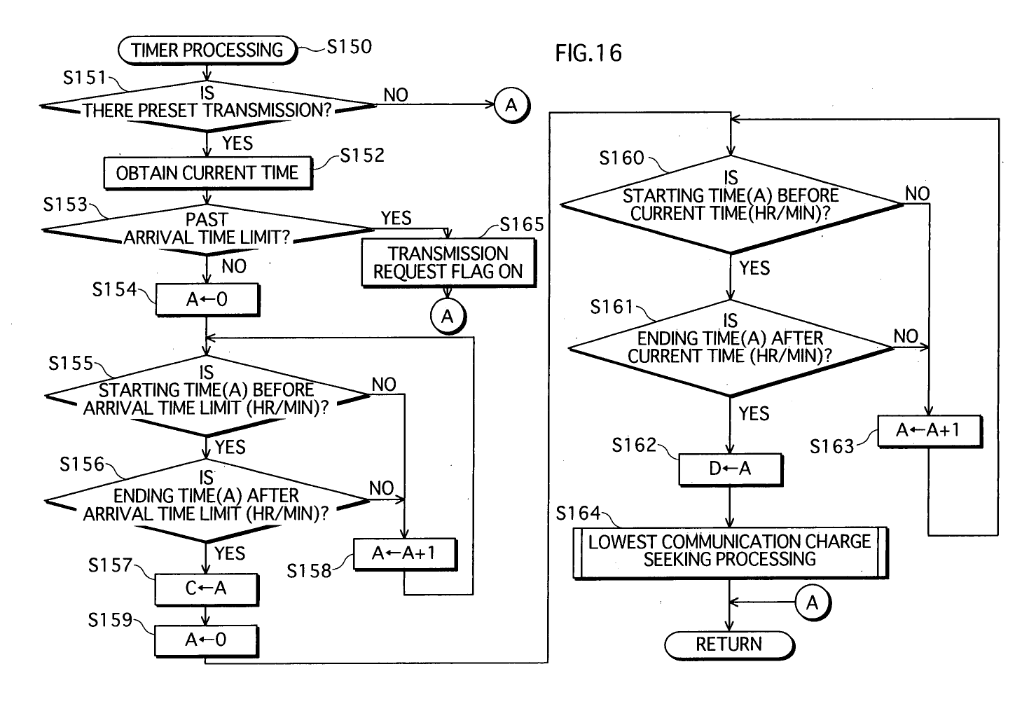

FIG. 16 is a flowchart illustrating a subroutine of the timer processing performed. The timer processing is to, after an arrival time limit has been set, refer to the charge information table 622 and count time for the appropriate time period, so that the FAX transmission is started during a time period that is before the arrival time limit and has the most inexpensive communication charge, in other words, so that the FAX machine 60 stands by without starting the FAX transmission until such most inexpensive time period comes (hereafter, referred to as “a preset transmission”).

As shown in the drawing, the controller 61 judges whether or not there is a preset transmission (Step S151). This judgment of whether there is a preset transmission is made by checking whether or not the preset transmission flag has been turned ON in Step S174 (to be described later). When the processing in Step S174 is completed, and one cycle of the routine has been finished, if the preset transmission flag is ON, the controller 61 judges that there is a preset transmission.

When the judgment result is that there is no preset transmission (Step S151: NO), the procedure returns to the main routine.

On the other hand, when the judgment result is that there is a preset transmission (Step S151: YES), the current time is obtained (Step S152). The current time is obtained through reception of information indicating the current time (date and time) from the clock IC 617.

Then, it is judged whether or not the current time is past the arrival time limit (Step S153). More specifically, the arrival time limit stored in the time limit information storing unit 620 is read so that the arrival time limit specified by the operator is obtained and it is judged which is earlier between the arrival time limit and the current time.

When the judgment result is that the current time is past the arrival time limit (Step S153: YES), the transmission request flag is turned ON so that the FAX transmission is immediately performed (Step S165), and the procedure returns to the main routine.

On the other hand, when the judgment result is that the current time is not past the arrival time limit (Step S153: NO), the value of Variable A is set as “0” (Step S154). The value of Variable A is used to express a time period number in the charge information table 622 shown in FIG. 4.

Then, the processing in Steps S155 and S156 is performed so that it is judged to which time period the specified arrival time limit belongs.

To be more specific, the charge information table 622 is referred to and “0:00 a.m.” is read as the starting time of the time period identified with the time period number “A” which is in the present case the time period number “0” (0:00 a.m. to 5:59 a.m.). (Hereafter, the time period identified with the time period number “A” will be referred to as “the time period (A)” and, the starting time thereof will be referred to as “the starting time (A)”.) Then, it is judged whether or not the read time is before the arrival time limit (Step S155). Specifically, it is judged whether or not the starting time (0) is positioned before the arrival time limit on a temporal axis of one day from 0:00 to 24:00. To be more specific, for example, when the arrival time limit is “8:00 a.m. on the 10^{th}”, only the time portion therein, i.e. “8:00 a.m.” is taken as the arrival time limit (hour/minute) and is compared with the starting time (0), which is “0:00 a.m.”, so that the judgment can be made as to which is earlier. In the present case, the starting time (0) is judged to be earlier than the arrival time limit (hour/minute) (Step S155: YES). The following gives explanation for the case in which the arrival time limit (hour/minute) is “8:00 a.m.”.

Next, the ending time of the time period “A” is read (hereafter, referred to as “the ending time (A)”), which is “5:59 a.m.”, and it is judged whether or not the ending time is after the arrival time limit (hour/minute) (Step S156). When the arrival time limit (hour/minute) is “8:00 a.m.”, the ending time “5:59 a.m.” is before the arrival time limit (hour/minute), it is judged that the ending time (0) is not after the arrival time limit (hour/minute) (Step S156: NO), and the procedure advances to Step S158.

In Step S158, the current value of Variable A is incremented by one. In the present case, the value of Variable A becomes “1”, and the procedure returns to Step S155. The processing in Steps S155 and S156 is performed again with the value of Variable A being “1”. When Variable A=“1” is satisfied, the starting time (1) is “6:00 a.m.”, and the ending time (1) is “10:59 p.m.”; therefore, the arrival time limit (hour/minute), which is 8:00 a.m., falls between those times (Step S155: YES; Step S156: YES). The procedure then advances to Step S157.

In Step S157, the current value of Variable A is set as the value of Variable C. In the example above, Variable C=1 is obtained. The value of Variable C denotes the time period number of a time period to which the arrival time limit (hour/minute) belongs. For example, in a case where the arrival time limit (hour/minute) is “5:00 a.m.”, “0” is set as Variable C. In a case where the arrival time limit (hour/minute) is “11:30 p.m.”, “2” is set as Variable C.

Once again, “0” is set as the value of Variable A (Step S159), the processing in Steps S160 and S161 is performed and judgment is made as to which time period the current time belongs.

Specifically, it is judged whether or not the starting time (0) is before the current time (Step S160). To be more specific, when the current time is “5:00 p.m. on the 9^{th}”, for example, only the time portion therein i.e. “5:00 p.m.” is taken as the current time (hour/minute), and compared with the starting time (0) which is “0:00 a.m.”, so that judgment can be made as to whether or not the current time is before the starting time (0). The following gives explanation for the case in which the current time (hour/minute) is “5:00 p.m.”.

In the present case, since the starting time (0) is judged to be before the current time (hour/minute) (Step S160: YES), it is judged whether or not the ending time (0), which is “5:59 a.m.” is after the current time (hour/minute) (Step S161). When the current time (hour/minute) is “5:00 p.m.”, the ending time “5:59 a.m.” is before the current time (hour/minute), the controller 61 judges that the ending time (0) is not after the current time (hour/minute) (Step S161: NO). The procedure then advances to Step S163.

In Step S163, the current value of Variable A is incremented by one. In the present example, the value of Variable A becomes 1, and the procedure returns to Step Sl60. Subsequently, the processing in Steps S160 and S161 is once again performed with the value of Variable A being “1”. When Variable A=“1” is satisfied, the starting time (1) is “6:00 a.m.”, and the ending time (1) is “10:59 p.m.”, the current time (hour/minute), which is 5:00 p.m., falls between those times (Step S160: YES; Step S161: YES). The procedure then advances to Step S162.

In Step S162, the current value of Variable A is set as the value of Variable D. In the example above, Variable D=1 is obtained. The value of Variable D denotes the time period number of a time period to which the current time (hour/minute) belongs. For example, in a case where the current time (hour/minute) is “5:00 a.m.”, “0” is set as Variable D. In a case where the current time (hour/minute) is “11:30 p.m.”, “2” is set as Variable D.

Subsequently, the lowest communication charge seeking processing is performed (Step S164).

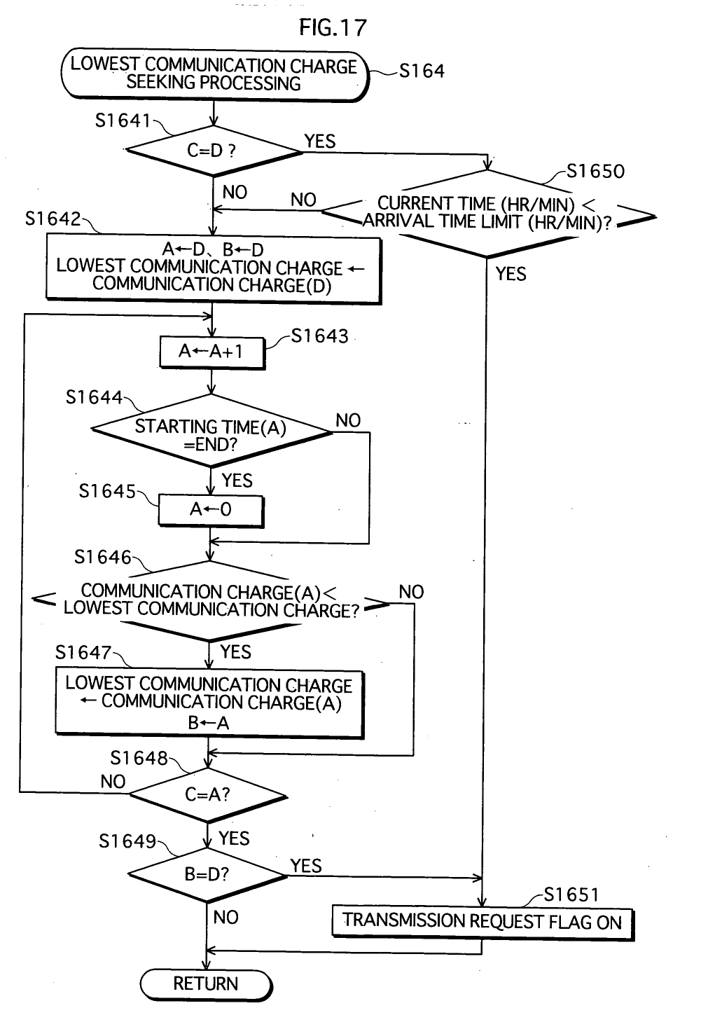

FIG. 17 is a flowchart illustrating a subroutine of the lowest communication charge seeking processing.

The lowest communication charge seeking processing is to (i) seek a time period that has the lowest communication charge by sequentially checking time periods, beginning with the time period to which the current time (hour/minute) belongs, and up to the time period to which the arrival time limit (hour/minute) belongs, and (ii) when the current time (hour/minute) reaches the time period with the lowest communication charge having been sought out, turn the transmission request flag “ON” in order to have the transmission started.

As shown in the drawing, the controller 61 firstly judges whether or not the current value of Variable C is equal to the current value of Variable D (Step S1641). In the example above, since Variable C and Variable D are both set as “1”, it is judged that they are equal (Step S1641: YES), and subsequently it is judged whether or not the current time (hour/minute) is before the arrival time limit (hour/minute) (Step S1650).

When the judgment result is that the current time (hour/minute) is before the arrival time limit (hour/minute) (Step S1650: YES), the transmission request flag is turned “ON” (Step S1651), the procedure returns to the subroutine of the timer processing.

The reason for the processing described above is because if the current time (hour/minute) belongs to the same time period as the arrival time limit (hour/minute) does, and also the current time (hour/minute) is before the arrival time limit (hour/minute), it is not possible to have the transmission performed before the arrival time limit unless the transmission is performed during the particular time period, and thus, there is no need to make comparison of communication charges in other time periods. As a specific example of such a situation, one can imagine a situation in which the current time (hour/minute) is “7:00 a.m.”, and the arrival time limit (hour/minute) is “8:00 a.m.”.

In the example described above, the current time is “5:00 p.m. on the 9^{th}”, the time portion therein i.e. “5:00 p.m.” is taken as the current time. It is judged that the current time (hour/minute) is after the arrival time limit (hour/minute), which is 8:00 a.m. (Step S1650: NO), and the procedure advances to Step S1642.

In Step S1642, the current values of Variable A and Variable B are each set as the value of Variable D. In addition, the lowest communication charge is set as the communication charge for the time period identified with the time period number “D” (referred to as “the time period (D)”). The value of Variable B denotes the time period number of a time period that has the lowest communication charge among the time periods beginning with the time period to which the current time (hour/minute) belongs and up to the time period to which the arrival time limit (hour/minute) belongs. In the present example, the value of Variable A and the value of Variable B are each set as “1”. The lowest communication charge is set as “3.3” yen.

Subsequently, the current value of Variable A is incremented by 1 (Step S1643). In the present example, A=2 is obtained.

The charge information table 622 is referred to and it is judged whether or not “end” is set as the starting time of the period “A” (Step S1644). In the present example, since the value of “A” is “2”, the starting time (2) is 11:00 p.m. Accordingly, it is judged that the starting time is not set as “end” (Step S1644: NO), and the procedure advances to Step S1646.

The controller 61 then judges whether or not the communication charge for the time period “A” is lower than the lowest communication charge being currently set (Step S1646).

Currently, the value of Variable A is “2”, and since the communication charge for the time period “2” is “2.5” yen, it is judged that this communication charge is lower than the lowest communication charge of “3.3” yen (Step S1646: YES). The lowest communication charge is reset so as to be “2.5” yen for the time period “2”, and also the value of Variable B is set so as be the current value of Variable A, which is “2” in the present situation (Step S1647).

Subsequently, it is judged whether or not the value of Variable C is equal to the value of Variable A (Step S1648). In the present example, since C=1 and A=2 are satisfied, it is judged that they are not equal (Step S1648: NO), and the procedure returns to Step S1643 where the current value of Variable A is incremented by 1. In the present example, A=3 is obtained. When Variable A=3 is satisfied, the charge information table 622 is referred to and it is judged that “end” is set as the starting time of the time period “3” (Step S1644: YES). The value of “A” is set as “0” (Step S1645), and the procedure advances to Step S1646.

Since the communication charge for the time period “0” is “2” yen, it is judged that this communication charge is lower than the current lowest communication charge (Step S1646: YES) and the lowest communication charge is reset as “2” yen which is the communication charge for the time period “0”, as well as the value of Variable B is reset so as to be the current value of Variable A, which is “0” (Step S1647).

Since the value of Variable C is “1”, and the value of Variable A is “0”, it is judged that C=A is not satisfied (Step S1648: NO), and the procedure returns to Step S1643. Then, the processing in Steps S1643 through S1648 is performed. In the present example, since the value of Variable A becomes “1”, and the communication charge (1) is “3.3” yen, it is judged that this communication charge is higher than the current lowest communication charge, which is “2” yen (Step S1646: NO). Accordingly, the lowest communication charge stays as “2” yen, and the value of Variable B also stays as “2”.

At this point, since both the value of Variable A and the value of Variable C are each “1”, it is judged that C=A is satisfied in Step S1648, and the procedure advances to Step S1649.

Through this processing, a time period that has the most inexpensive communication charge has been sought out by checking the communication charges of different time periods sequentially, beginning with the time period (1) to which the current time (hour/minute) belongs, and then the time period (2) and the time period (0), and up to the time period (1) to which the arrival time limit (hour/minute) belongs. Thus, the time period number of the time period with the most inexpensive communication charge, which is “2” in the present example, has been set as the value of Variable B.

In Step S1649, it is judged whether or not the value of Variable B is equal to the value of Variable D. As explained above, the value of Variable D is the time period number of the time period to which the current time (hour/minute) belongs. When the value of Variable B is equal to the value of Variable D, it means that the current time (hour/minute) has fallen into the most inexpensive time period. Conversely, when the value of Variable B is not equal to the value of Variable D, it means that the current value has not fallen into the most inexpensive time period yet.

In the example described above, since the current time is assumedtobe “5:00 p.m. on the 9^{th}”, D=1 is obtained; therefore, it is judged that B=D is not satisfied (Step S1649: NO), and the procedure returns to the subroutine of the timer processing.

On the other hand, when it has been judged that B=D is satisfied (Step S1649: YES), it is understood that the most appropriate time to perform transmission has come, and the procedure advances to Step S1651 where the transmission request flag is turned “ON”. Then, the procedure returns to the subroutine of the timer processing.

The controller 61 performs the timer processing as described above for every cycle of routine. Every time the controller 61 performs the timer processing, the current time at that point is obtained, and when the current time has fallen into a time period that is before the arrival time period (hour/minute) and has the most inexpensive communication charge (in the example described above, at the starting time of the time period “0” which is 0:00 a.m.), the transmission request flag is turned “ON” so that the transmission is started. In this respect, while performing the timer processing, the controller 61 serves as a determining unit that is operable to determine the time period that is before the arrival time period and during which the image information should be forwarded.

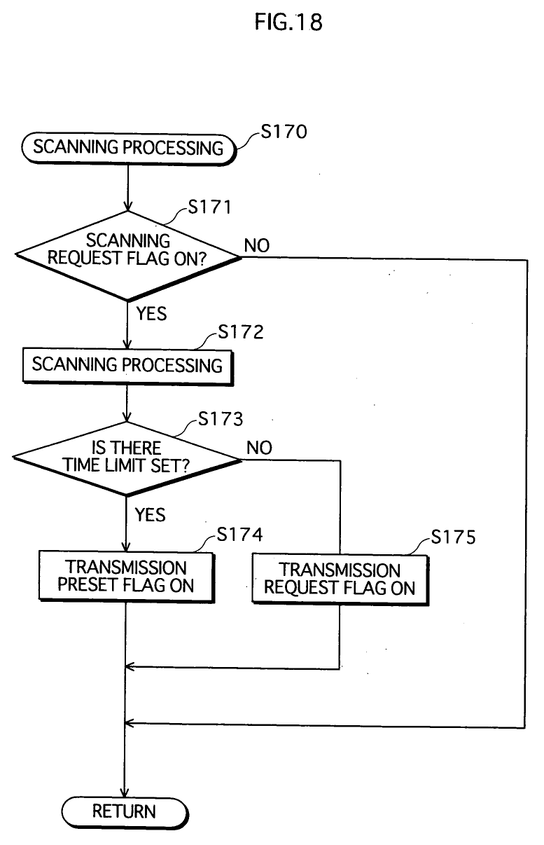

FIG. 18 is a flowchart illustrating a subroutine of the scanning processing.

As shown in the drawing, the controller 61 judges whether or not the scanning request flag is “ON” (Step S171). In Step S112 described above, the scanning request flag may have been turned “ON”.

When it has been judged that the scanning request flag is not “ON”, in other words, that it is “OFF” (Step S171: NO), the procedure just returns to the main routine.

When it has been judged that the scanning request flag is “ON” (Step S171: YES), the scanning processing is performed (Step S172). More specifically, the controller 61 instructs the scanner 61 to read image from a document, and has the obtained image information stored into the image storing unit 618.

Subsequently, it is judged whether or not there is an arrival time limit having been set (Step S173). This judgment is made by checking if time limit information is stored in the time limit information storing unit 620.

When the judgment result is that there is an arrival time limit set, in other words, that time limit information is stored (Step S173: YES), the preset transmission flag is turned “ON” (Step S174) so that the FAX transmission is performed in a time period that is before the time limit and has the most inexpensive communication charge, and the procedure returns to the main routine. Accordingly, now there is a preset transmission (in Step S151 described above: YES), and the transmission is automatically performed when the time period with the most inexpensive communication charge comes.

On the other hand, when the judgment result is that there is no arrival time limit set, in other words, that no time limit information is stored (Step S173: NO), the transmission request flag is turned “ON” so that the FAX transmission is performed immediately (Step S175), and the procedure returns to the main routine.

With reference back to FIG. 13, in Step S180, when a call from another FAX machine has been received, the FAX reception processing is performed so that image information is received with the use of a conventional FAX transmission control procedure.

In Step S190, when image information has been received as a FAX reception, the printing processing is performed in which the printer 63 is instructed to print out the image information. In addition, when various kinds of reports need to be printed out, those reports are printed out as well.

Subsequently, the transmission processing in Step S200 is performed.

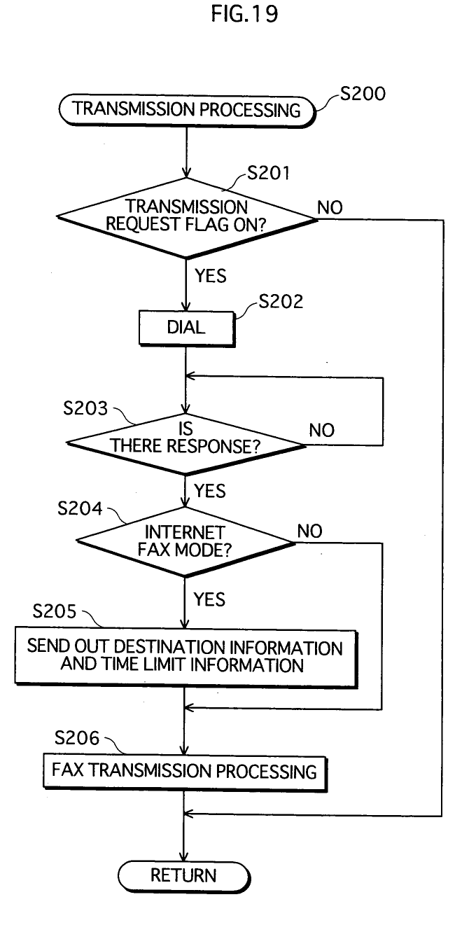

FIG. 19 is a flowchart illustrating a subroutine of the transmission processing.

As shown in the drawing, the controller 61 judges whether or not the transmission request flag is “ON” (Step S201). In Step S165, S1651, or S175 described above, the transmission request flag may have been turned “ON”.

When the judgment result is that the transmission request flag is not “ON”, in other words, that it is “OFF” (Step S201: NO), the procedure just returns to the main routine.

When the judgment result is that the transmission request flag is “ON” (Step S201: YES), the destination having been specified is dialed (called), e.g. the transmission destination in a case of a normal FAX transmission, and a relay apparatus in a case of a transmission by an Internet FAX. In the present case, the dialing is made to the MFP 100 serving as an onramp (Step S202).

When there is a response from the transmission destination (Step S203: YES), it is judged whether or not the transmission is performed by an Internet FAX (Step S204). This judgment is made by checking if the Internet FAX mode flag is “ON”. In Step S120 described above, the Internet FAX mode flag may have been turned “ON”.

When the judgment result is that the transmission is by an Internet FAX, in other words, that the Internet FAX mode flag is “ON” (Step S204: YES), the destination information and the time limit information are sent out (Step S205). More specifically, the destination information is read from the destination information storing unit 619 and also the time limit information is read from the time limit information storing unit 620. Those kinds of information having been read are converted into tone signals so that the MFP 100 can be notified, and the converted tone signals are sent out.

For example, when the telephone number of the final destination is “112349876” and the arrival time limit is “8:00 a.m. on the 10^{th}”, these pieces of information are arranged into a sequence of codes that reads “112349876##100800” and the codes in the sequence are converted, one by one from the beginning of the sequence, into tone signals of specific frequencies that have been assigned to those codes in advance, and the tone signals are sent out.

Accordingly, it is possible to notify the MFP 100 of the destination information and the time limit information. When the MFP 100 has received the tone signals, the MFP 100 converts them back into a sequence of numeric values and obtains the destination information and the time limit information. It means that it is desirable that the FAX machine and the MFP have prearrangement with each other as to which code corresponds to a tone signal of which frequency, so that they are able to perform the conversion and the reverse conversion. It should be noted that the set of codes “##” is used as a delimiter to separate the destination telephone number from the arrival time limit. The delimiter codes are not limited to this example, and it is acceptable to use other kinds of codes as long as they function as a delimiter.

Furthermore, the information does not have to be sent out with the use of tone signals. For example, it is acceptable to send out the destination telephone number and the arrival time limit by putting them into the FIF information that follows the SUB signal in a FAX transmission control procedure.

On the other hand, when the judgment result is that the transmission is not by an Internet FAX, in other words, that the Internet FAX mode flag remains “OFF” (Step S204: NO”), it is understood that the transmission is a normal FAX transmission, and the procedure advances to Step S206. In such a case, naturally the destination information and the time limit information will not be sent.

In Step S206, the image information stored in the image storing unit 618 is read and transmitted, as a FAX transmission, to the MFP 100 with the use of a predetermined FAX transmission control procedure, and the procedure returns to the main routine.

In this respect, while performing the processing described in Step S205, the controller 61 serves as a transmitting unit that is operable to transmit the time limit information to the MFP 200 serving as a relay apparatus.

6. The Processing Performed by The MFP 100 Serving as the Onramp

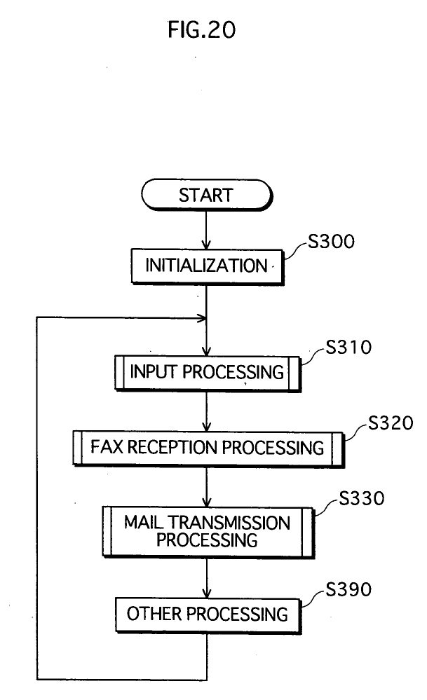

FIG. 20 is a flowchart illustrating the main routine of the processing performed by the controller 110 of the MFP 100.

As illustrated in the figure, the controller 110 first performs initialization (step S300). Through the initialization, the RAM 116 is cleared, and the flags are reset, in the similar manner as the processing performed in Step S100 described above.

After the initialization, input processing (Step S310), FAX reception processing (Step S320), e-mail transmission processing (Step S330), and other processing (Step S390) are sequentially performed.

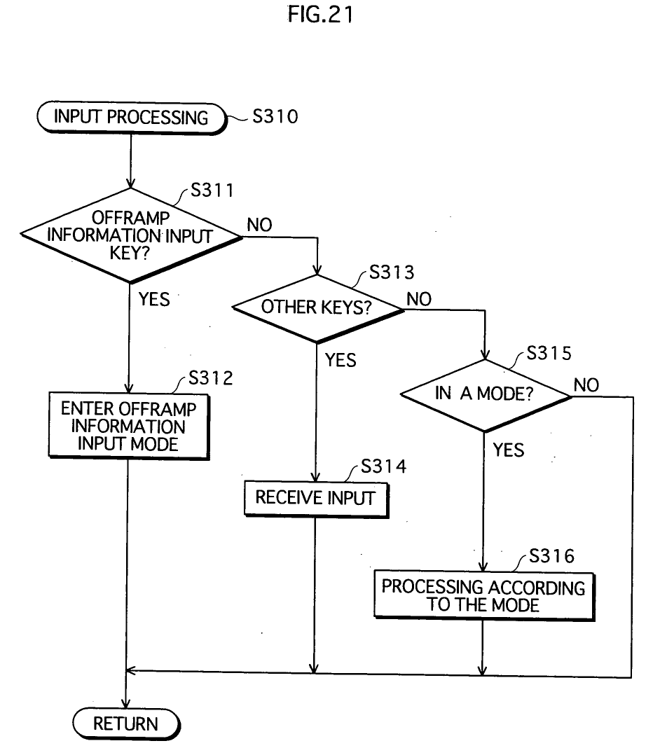

FIG. 21 is a flowchart illustrating a subroutine of the input processing. The input processing is to, when a key input has been made on the operation panel 150 by the operator, perform the reception processing of the input.

As shown in the drawing, the controller 110 judges whether or not the offramp information input key 156 has been pushed (Step S311).

When the judgment result is that the offramp information input key 156 has been pushed (Step S311: YES), the MFP 100 enters the offramp information input mode (Step S312), and the procedure returns to the main routine.

When the judgment result is that a key other than the offramp information input key 156 has been pushed (Step S311: NO; Step S313: YES), the processing of receiving the key input having been pushed is performed (Step S314), and the procedure returns to the main routine.

When the judgment result is that no key has been pushed (Step S313: NO), it is judged whether or not the MFP 100 is in the offramp information input mode (Step S315). When the judgment result is that the MFP 100 is in the offramp information input mode (Step S315: YES), the processing of receiving the offramp information inputted by the operator in the mode is performed (Step S316), and the procedure returns to the main routine. More specifically, when the MFP 100 is in the offramp information input mode, since the telephone number and the domain name of the offramp are inputted by the operator as offramp information, those kinds of information are stored into the offramp information table 118. When the judgment result is that the MFP 100 is not in the offramp information input mode (Step S315: NO), the procedure just returns to the main routine.

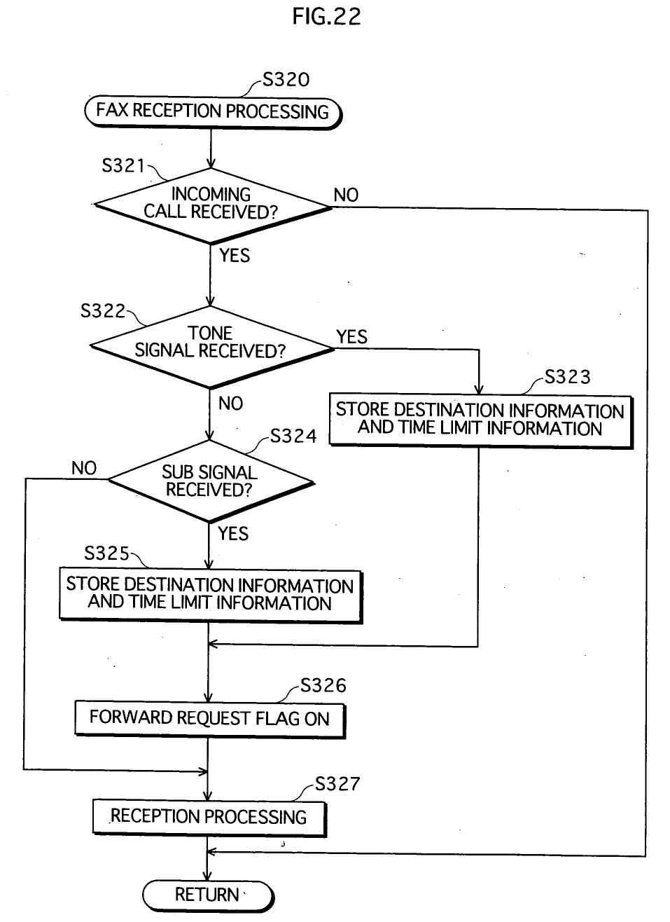

FIG. 22 is a flowchart illustrating a subroutine of the FAX reception processing.

As shown in the drawing, the controller 110 judges whether or not there is an incoming call from a FAX machine. When the judgment result is that there is no incoming call (Step S321: NO), the procedure just returns to the main routine.

On the other hand, when the judgment result is that there is an incoming call (Step S321: YES), the FAX reception processing according to a FAX transmission control procedure is started, and it is judged whether or not the MFP 100 has received tone signals from a sending end (in this case the FAX machine 60) within a predetermined length of time (for example, 15 seconds) (Step S322). The tone signals may have been sent out from the FAX machine 60 in Step S205 described above.

When the judgment result is that the tone signals have been received (S322: YES), the received signals are converted into a sequence of numerals indicating the destination telephone number and the arrival time limit, and the destination information (in the example described above, “112349876” as the destination telephone number) and the time limit information (in the example described above, “100800”) resulting from the conversion are stored into the RAM 116 temporarily (Step S323). The procedure then advances to Step S326. The tone signals are converted into the sequence of numerals through calculation of the frequency values of the received tone signals and checking to which code each value has been assigned as the frequency thereof.

On the other hand, when no tone signals have been received (Step S322: NO), the procedure advances to Step S324.

In Step S324, it is judged whether or not a SUB signal has been received. When the judgment result is that a SUB signal has been received (Step S324: YES), the destination information and the time limit information contained in the FIF information are extracted, and then stored into the RAM 116 temporarily (Step S325). The procedure then advances to Step S326.

In Step S326, the reception of the destination information and the time limit information from the sending end is construed as a forward request (in other words, the MFP 100 is supposed to function as an onramp), and the forward request flag is turned “ON”. The procedure then advances to Step S327.

On the other hand, when no SUB signal has been received (Step S324: NO), the procedure advances to Step S327.

In Step S327, the image information transmitted from the sending end is received according to a predetermined FAX transmission control procedure, and the image information is stored in to the RAM 116 temporarily. The procedure then returns to the main routine.

When no tone signal or no SUB signal has been received from the FAX machine 60 serving as the sending end (Step S322: NO; Step S324: NO), it is understood that the reception is a normal FAX reception (the judgment result in Step S204 for the FAX machine 60 is “NO”). Accordingly, the MFP 100 does not function as an onramp and the forward request flag remains “OFF”, and the image information is printed out in the other processing (Step S390).

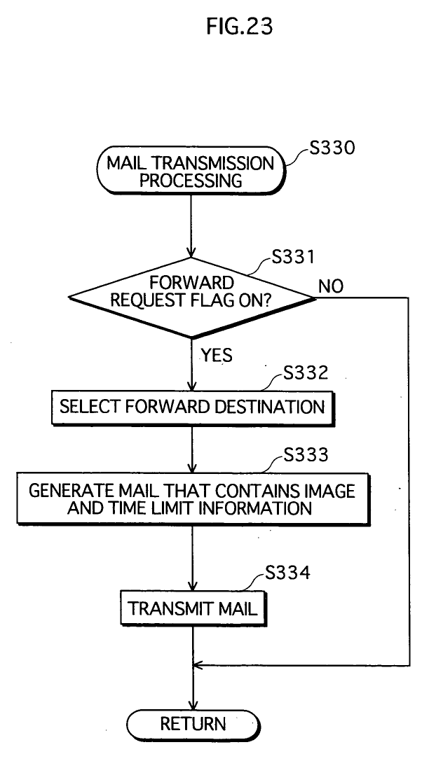

FIG. 23 is a flowchart illustrating a subroutine of the e-mail transmission processing.

As shown in the drawing, the controller 110 judges whether or not the forward request flag is “ON” (Step S331). In Step S326 described above, the forward request flag may have been turned “ON”.

When the judgment result is that the forward request flag is not “ON”, in other words, that it is “OFF” (Step S331: NO), the procedure just returns to the main routine.

On the other hand, when the judgment result is that the forward request flag is “ON” (Step S331: YES), the forward destination selecting processing is performed for selecting an offramp serving as a forward destination (Step S332). This processing of selecting a forward destination is to select one of the offramps in the case where there are a plurality of offramps that each may serve as a relay apparatus. As a method of selection, in order to make the communication charge as inexpensive as possible, it is acceptable to calculate communication charges for all the possible communication paths to the final destination based on the area codes within the telephone numbers of the FAX machines serving as the relay apparatuses and the final destination, and to select one of the offramps that is able to establish the communication path with the most inexpensive communication charge. Needless to say, alternatively, it is acceptable to manage the FAX machine serving as the final destination in prearranged correspondence with offramps that each may serve as a forward destination, and select an offramp that corresponds to the specified final destination.

In the present embodiment, the following explanation will be provided on an assumption that the offramp identified with the offramp number “0” (i.e the MFP 200) is selected as the most appropriate offramp from among the offramps stored in the offramp information table 118.

In Step S333, an e-mail that contains the time limit information is generated. More specifically, the destination information, the time limit information, and the image information stored in the RAM 116 are read. At this point, a processing is performed to convert the read arrival time into a time according to the Greenwich Mean Time, in consideration of a possibility that the final destination is located in a foreign country which has a time difference from the sending end located in Japan. More specifically, when the arrival time limit is 8:00 a.m. Japan Time, it is 11:00 p.m. on the previous day (the 9^{th}) according to the Greenwich Mean time. Accordingly, the information indicating the arrival time limit is converted so as to read “092300GMT”. It should be noted that “GMT” is a set of codes to express that the information is expressed according to the Greenwich Mean Time.

Subsequently, after the read image information is converted into a file (for example TIFF) based on MIME (Multipurpose Internet Mail Extensions), an e-mail is generated to which the file resulting from the conversion is attached as an attachment file and in which the read destination telephone number, the arrival time limit after the conversion, the @ symbol, and the domain name of the offramp serving as the forward destination (in this case the MFP 200) are written into the “To” field. To be more specific, in the generated e-mail, “FAX=+112349876##092300GMT@offramp.com” is written in the “To” field. The generated e-mail is forwarded to the offramp serving as the forward destination via the Internet 50 with the use of, for example, SMTP (Simple Mail Transfer Protocol) (Step S334). The procedure then returns to the main routine.

It is desirable that there is prearrangement with the offramp serving as the forward destination as to at which positions the destination telephone number and the arrival time limit are written, so that the offramp is able to obtain the destination telephone number and the arrival time limit from the received e-mail. In the example described above, the offramp obtains the numerals located between “FAX=” and “##” in the “To” field as the destination telephone number, and the codes located between “##” and “@” as the arrival time limit.

It should be noted that the set of codes “##” is used as a delimiter to separate the destination telephone number from the arrival time limit; however, the delimiter codes are not limited to this example, as long as the delimiter codes are able to notify the offramp serving as a forward destination of the destination telephone number and the arrival time limit. For example, it is acceptable to attach the arrival time limit into the header of an e-mail. In such a case, “X-TIME-OF-DELIVERY:09:23:00GMT” is attached into the header of an e-mail as the arrival time limit, and “FAX=+112349876@offramp.com” is written into the “To” field as an address.

With reference back to FIG. 20, in Step S390, as the other processing, processing according to an input instruction made on the operation panel 150, for example, the processing of starting a copy job is performed. The procedure then returns to Step S310.

7. The Processing Performed by the MFP 200 Serving as the Offramp

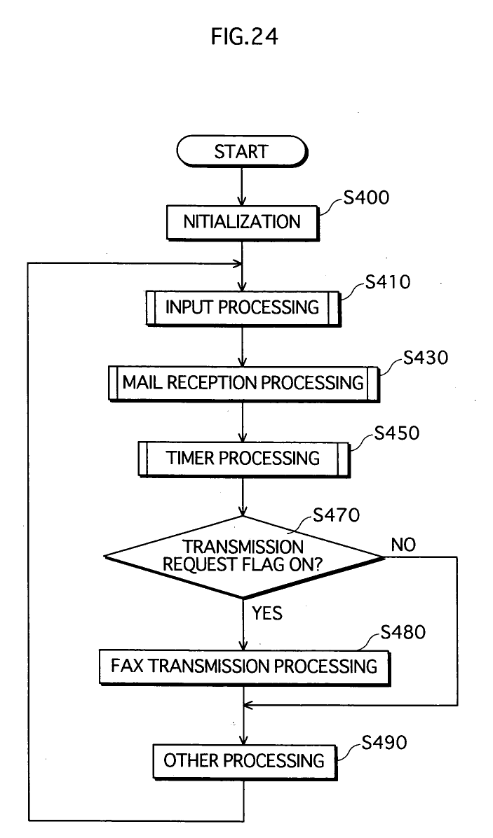

FIG. 24 is a flowchart illustrating the main routine of the processing performed by the controller 210 of the MFP 200.

As shown in the drawing, the controller 210 first performs initialization (Step S400). Through the initialization, the RAM 216 is cleared, and the flags are reset, in the similar manner as the processing performed in Step S100 described above.

After the initialization, input processing (Step S410), mail reception processing (Step S430), timer processing (Step S450), FAX transmission processing (Step S480), and other processing (Step S490) are sequentially performed.

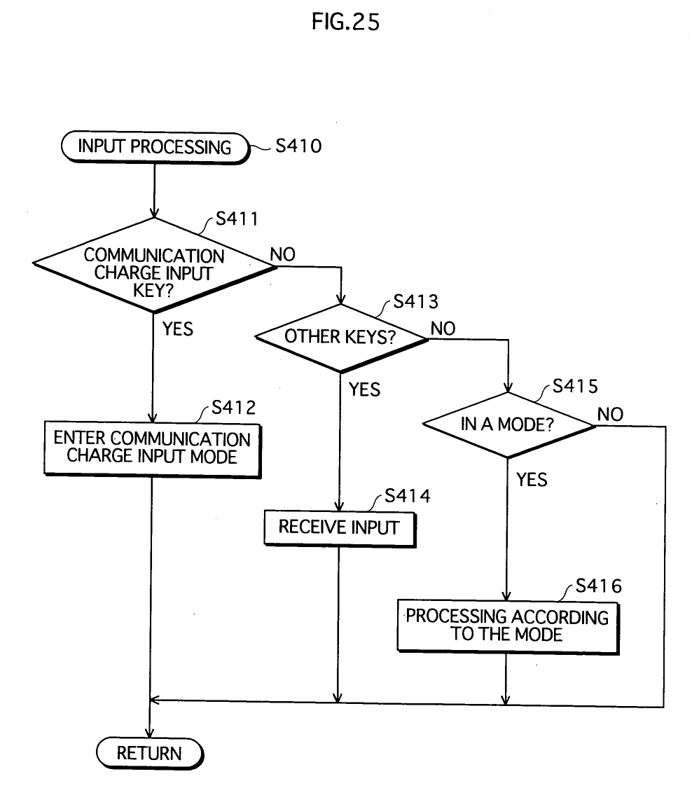

FIG. 25 is a flowchart illustrating a subroutine of the input processing. The input processing is to, when a key input has been made on the operation panel 240 by the operator, perform the reception processing of the input.

As shown in the drawing, the controller 210 judges whether or not the communication charge input key 246 has been pushed (Step S411).

When the judgment result is that the communication charge input key 246 has been pushed (Step S411: YES), the MFP 200 enters the communication charge input mode (Step S412), and the procedure returns to the main routine.

When the judgment result is that any other key besides the communication charge input key 246 has been pushed (Step S411: NO; Step S413: YES), the processing of receiving the key input having been pushed is performed (Step S414), and the procedure returns to the main routine.

When the judgment result is that no key has been pushed (Step S413: NO), it is judged whether or not the MFP 200 is in the communication charge input mode (Step S415). When the judgment result is that the MFP is in the communication charge input mode (Step S415: YES), the processing of receiving the communication charge information inputted by the operator in the mode is performed (Step S416). The procedure then returns to the main routine.

Here, in the case where the communication charges vary depending on not only time periods but also distances, this process makes it possible to input the charges in a pricing system that vary depending on distances. More specifically, by the display unit 241, a screen (not shown in the drawing) is displayed in which a plurality of boxes into which distance ranges having different charges are to be inputted, so that inputs of distance ranges can be received from the operator. For example, when the pricing system is classified into three levels such as “up to 20 kilometers”, “20 to 100 kilometers”, and “over 100 kilometers”, the operator is able to input “0-20” into the first box, “20-100” into the second box, and “100-” into the third box with the use of the ten-key pad 242 and the like. When one of the boxes in the display is touched by the operator, the controller 210 has an input receiving screen (not shown in the drawing) displayed so that the operator is able to input the charges for different time periods corresponding to the distance range inputted in the box. The input receiving screen is identical to the input receiving screen used in the communication charge input mode described in Step S128 for the FAX machine 60. In other words, as shown in FIG. 10, the input receiving screen is in a table format in which the time periods are shown in correspondence with the starting times and so on. Thus, the operator is able to input the starting times and other information into the sections under the starting time column and so on.

The controller 210 has the data having been inputted into the first box stored into the charge information table 2171. At that time, the controller 210 also has the information about the distance range “0-20 kilometers” stored into the distance column. In the similar manner, the data having been inputted into the second box is stored into the charge information table 2172, and the data having been inputted in the third box is stored into the charge information table 2173. The pieces of information about the distance ranges (“20-100 kilometers” and “over 100 kilometers”) are also stored into the distance column. It should be noted that when the number of the distance ranges are different, for example when there are two or four or more distance ranges, as many charge information tables as the number of distance ranges are provided so that each charge information table corresponds to one distances range.

When the judgment result is that the MFP 200 is not in the charge information input mode (Step S415: NO), the procedure just returns to the main routine.

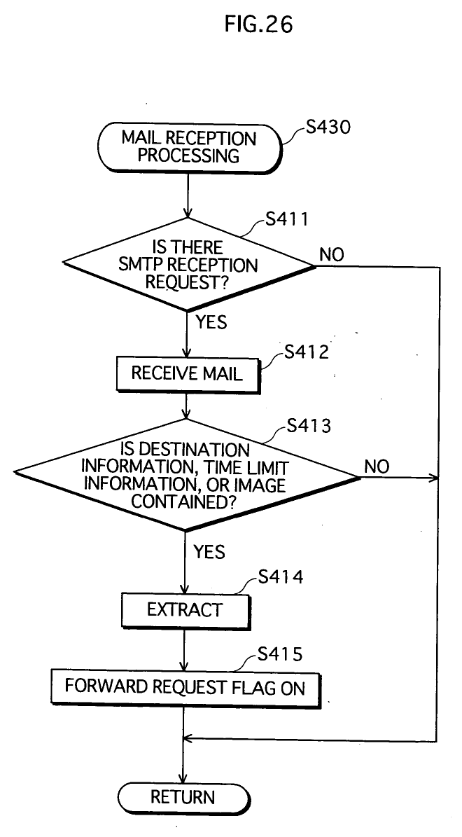

FIG. 26 is a flowchart illustrating a subroutine of the e-mail reception processing.

As shown in the drawing, the controller 210 judges whether or not there is an SMTP reception request (Step S411). This judgment is made by having access to the mail server 202 once every minute, for example, and checking if one or more e-mails addressed to own (the MFP 200) have been delivered.

When it has been judged that there is an e-mail addressed to the MFP 200 having been delivered (Step S411: YES), the e-mail is acquired (Step S412).

Then, it is judged whether or not the acquired e-mail contains destination information, time limit information, and image information (Step S413). More specifically, it is judged whether or not destination information and time limit information are written in a predetermined position of the header, e.g. in the “To” field, in the example described above, and whether image information is attached as an attachment file.

When it has been judged that those kinds of information are contained in the e-mail (Step S413: YES), such pieces of information are extracted, and the extracted destination information is stored into the destination information storing unit 220, and the extracted time limit information is stored into the time limit information storing unit 221, and the extracted image information is stored into the image storing unit 219 (Step S414). At this time, since the arrival time limit indicated in the extracted time limit information is expressed according to Greenwich Mean Time as a result of the conversion performed in Step S333, the arrival time limit is converted into the standard time of the own country (i.e. the U.S.A.). For example, if City B is New York, since New York is five hours behind Greenwich Mean Time, “five” hours is subtracted from the time expressed according to Greenwich Mean time. For example, when the arrival time limit is “092300GMT”, the arrival time limit after the conversion is 6:00 p.m. on the 9^{th} (Eastern Standard Time in the U.S.A.). The arrival time limit after the conversion is stored into the time limit information storing unit 221, as the arrival time limit specified by the operator at the sending end.

In this respect, while performing the processing of Steps S411 through S414, the controller 210 serves as a reception unit that is operable to receive the time limit information having been transmitted from the transmission apparatus (the FAX machine 60).

Subsequently, the fact that the destination information is contained in the e-mail is construed that the MFP 200 is supposed to function as an offramp, and the forward request flag is turned “ON” (Step S415). The procedure then returns to the main routine.

On the other hand, when it has been judged that no destination information or the like is contained in the received e-mail (Step S413: NO), the procedure just returns to the main routine.

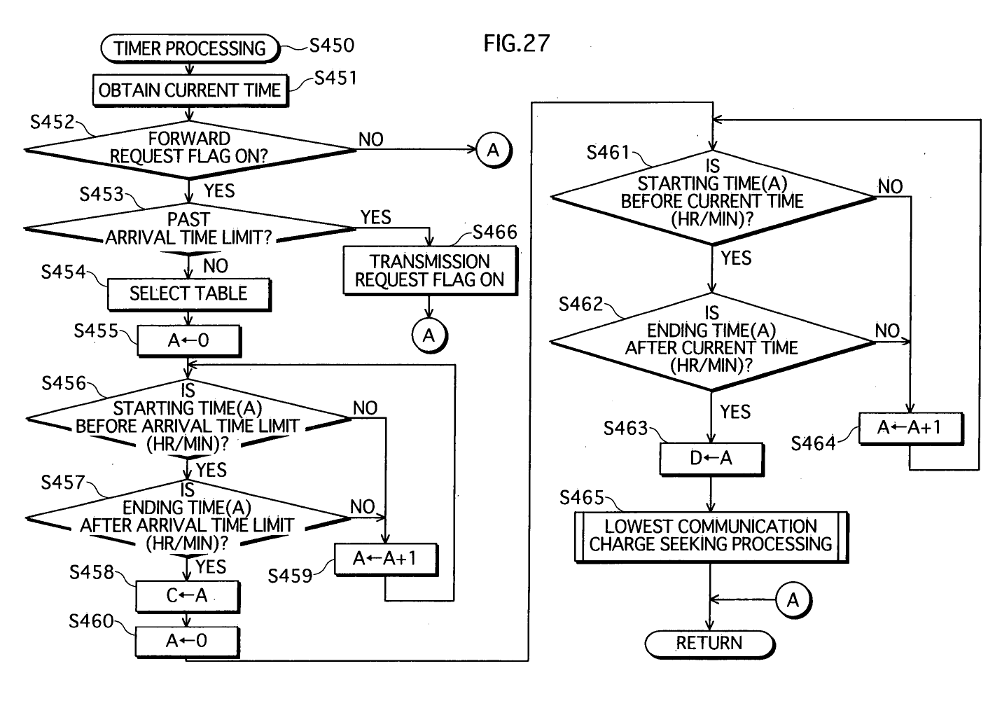

FIG. 27 is a flowchart illustrating a subroutine of the timer processing. The timer processing is to count time for the appropriate time period so that the FAX transmission to the final destination is started in a time period that is before the arrival time limit and has the most inexpensive communication charge. The timer processing here is similar to the one shown in FIG. 16 except for some parts thereof; therefore, the following mainly describes the different parts, and explanation for the common parts will be omitted.

As shown in the drawing, the controller 210 first obtains the current time (Step S451). The current time is obtained through reception of information indicating the current time from the clock IC 218. Then, it is judged whether or not the forward request flag is “ON” (Step S452). In Step S326 described above, the forward request flag may have been turned “ON”. When the judgment result is that the forward request flag is not “ON”, in other words, that the forward request flag remains “OFF” (Step S452: No), the procedure just returns to the main routine.

On the other hand, when the judgment result is that the forward request flag is “ON”, (Step S452: YES), it is judged whether or not the current time is past the arrival time limit (Step S453). More specifically, the arrival time limit stored in the time limit information storing unit 221 (the arrival time limit after the conversion according to the Eastern Standard Time in the U.S.A.) is read and compared with the current time (Eastern Standard Time in the U.S.A.) in order to make judgment as to which is earlier.

When the judgment result is that the current time is past the arrival time limit (Step S453: YES) the transmission request flag is turned “ON” so that the forwarding is performed immediately (Step S466), and the procedure returns to the main routine. When the judgment result is that the current time is not past the arrival time limit (Step S453: NO), the procedure advances to Step S454.

In Step S454, one of the tables out of the three charge information tables 2171, 2172, and 2173 is selected as a most appropriate table for seeking a time period. As a method of this selection, in the present example, judgment is made as to which one of the distance ranges shown in the charge information tables corresponds to the distance between the own machine and the FAX machine at the final destination specified as the forward destination. It should be noted that since the method for obtaining the distance between the own machine and the final destination is publicly known, detailed description thereof will be omitted. However, it is acceptable, for example, to prepare a table in which telephone number area codes are shown in correspondence with approximate distances between pairs of area codes so that the distance can be obtained by reading the distance information for the two area codes from the table, based on the own area code and the area code of the final destination.

After a table has been selected, the processing in and after Step S455 will be performed.

The processing in Steps S455 through S465 corresponds to the processing in Steps S154 through S164 in the timer processing shown in FIG. 16, and what is performed in the processing is substantially the same. Specifically, the charge information table that has been selected in the table selection process is referred to, in order to seek a time period that has the most inexpensive communication charge by checking each of the time periods that exist between the current time (hour/minute) and the arrival time limit (hour/minute). When the current time (hour/minute) reaches the most inexpensive time period, the transmission request flag is turned “ON” so that the forwarding is started. In this respect, while performing the timer processing, the controller 210 serves as a determining unit that is operable to determine a time period which is before the arrival time limit and during which the image information is to be forwarded.

With reference back to FIG. 24, in Step S470, it is judged whether or not the transmission request flag is “ON”. In Step S465, or S466, the transmission request flag may have been turned “ON”.

When it has been judged that the transmission request flag is “ON” (Step S470: YES), the forwarding processing performed by an offramp, which is in the present example the FAX transmission processing, is performed (Step S480).

More specifically, the image information (TIFF or the like) stored in the image storing unit 219 is read and converted into data for a FAX transmission. Subsequently, the destination information stored in the destination information storing unit 220 is read so that the telephone number of the final destination (the FAX machine 70) can be obtained, and a call is made to the obtained telephone number. When a connection is established with the FAX machine 70, the image information which has been converted into data for FAX transmission is transmitted, as a FAX transmission, according to a FAX transmission control procedure, to the FAX machine 70 serving as a reception apparatus. In this respect, while performing the FAX transmission processing described above, the controller 210 serves as a forwarding unit that is operable to forward the image information to the reception apparatus. It should be noted that the received image information is printed out by the FAX machine 70 in Step S190 described above.

On the other hand, when it has been judged that the transmission flag is not “ON”, in other words, that the transmission flag is “OFF” (Step S470: NO), the procedure advances to Step S490.

In Step S490, as the other processing, processing according to an input instruction made on the operation panel 240, for example, the processing of starting a copy job is performed. Then procedure then returns to Step S410.

As described so far, according to the system 1 of the present embodiment, when the operator has set, at the sending end (the FAX machine 60), a time limit by which image information should arrive at the final destination, there is an arrangement wherein the sending end and the offramp (the MFP 200) each transmit the image information during a time period that is before the arrival time limit and has the most inexpensive charge for communication over a public network.

Accordingly, the user at the sending end does not have to think at all about communication charges when having FAX transmissions performed. Furthermore, the image information is transmitted during a time period that is before the specified arrival time limit and has the most inexpensive communication charge. In comparison, for example, if there was an arrangement wherein the transmission is performed simply during a time period that has the most inexpensive communication charge, in a case where the user issues a transmission instruction immediately after the end of the most inexpensive time period of the day, the transmission would be on hold (transmission is preset) for almost another day until the next most inexpensive time period comes, and the arrival of the image information to the final destination would be extremely late. The arrangement of the present invention makes it possible to avoid this kind of situation.

Thus, in a case where a user at the sending end and a user at the final destination hold a TV conference using a same set of documents, if the user at the sending end performs the operation, on the previous day of the conference, to prearrange transmission of the set of documents by the FAX machine at the sending end by specifying the time one hour prior to the beginning of the conference as the arrival time limit, it is possible to have the set of documents forwarded to the FAX machine at the final destination during a time period that is before the beginning of the conference and has the most inexpensive communication charge over the public network. Thus, it is possible to achieve the effects of reducing the communication charges and also preventing delays of document delivery.

Further, the user at the sending end is able to specify the time limit using the standard time of his/her own location. Accordingly, there is no need to adjust the time limit according to the standard time of the location of the relay apparatus, and it is easy for the operator to specify the time limit.

The present invention may be embodied not only as the specific system, onramp, offramp, and FAX machine described above, but also as a method as described above. Further, the present invention may be embodied as a program to have a computer execute the method. The program of the present invention may be stored in a computer-readable recording medium of various types. Examples of such a recording medium include a magnetic tape, a magnetic disk such as a flexible disk, an optical medium such as a DVD, a CD-ROM, a CD-R, an MO and a PD, and a flash memory such as Smart Media (Registered Trademark). Still further, the present invention may be manufactured or transferred in the form of such a recording medium, and transmitted and provided in the form of a program via a wired or wireless network of various types, such as the Internet, broadcast, an electronic communication network, and satellite communications.

Further, a program according to the present invention does not need to include all the modules for having a computer execute the processing described above; it is acceptable to make use of a general-purpose program of various types that can be individually installed on a information processing apparatus such as a program included in a communication program or an operating system (OS), in order to have a computer execute the processing of the present invention. Accordingly, a recording medium according to the present invention does not have to have all the modules described above recorded thereon. Not all the modules necessarily have to be transmitted or distributed, either. Further, there is a possibility of having some predetermined processing executed with the use of hardware provided exclusively for the purpose.

### MODIFICATION EXAMPLES

The present invention has been explained so far according to the embodiment; however, needless to say, the present invention is not limited to the embodiment described above. It is acceptable to modify the invention as in the following modification examples:

(1) In the embodiment described above, the timer processing of seeking a time period that is before the arrival time limit and has the most inexpensive communication charge is performed by the FAX machine 60 serving as a transmission apparatus and also by the MFP 200 serving as a relay apparatus; however, it is acceptable that only one of these machines perform the timer processing.

For example, when there is an arrangement wherein only the transmission apparatus performs the timer processing, it is possible to reduce the charges for communication between the FAX machine 60 and the MFP 100. When there is an arrangement wherein only the relay apparatus performs the timer processing, it is possible to reduce the charges for communication between the MFP 200 and the FAX machine 70. Thus, when only one of those machines performs the timer processing, it is possible to make the effects of reducing the communication charges larger by arranging so that a machine located on a transmitting end of a line that has a more expensive communication charge.

Further, the embodiment described above presents an arrangement wherein the most inexpensive time period is sought out; however, the present invention is not limited to seeking the most inexpensive time period. It is acceptable to have an arrangement wherein a time period that is advantageous in terms of communication charges is sought out, for example, a time period that has the most or the second most inexpensive communication charge is sought out. It is possible to achieve the effects of reducing the communication charges by avoiding time periods that have expensive communication charges.

(2) Further, in the embodiment described above, transmission is performed from the FAX machine 60 serving as the sending end, via the MFP 100 and the MFP 200, to the FAX machine 70 serving as the final destination, with the use of the Internet FAX mode; however, it is sufficient for the present invention if the system is able to transmit image information during a time period that is before a specified arrival time limit and has an inexpensive communication charge. In this respect, the present invention is not limited to the arrangement described above. It is acceptable to have the following arrangements, for example:

(i) A system in which image information is transmitted from the MFP 100, via the MFP 200, to the FAX machine 70, wherein the MFP 100 serves as the transmission apparatus, the MFP 200 serves as the relay apparatus, and the FAX machine 70 serves as the reception apparatus.

In this example, there is an arrangement wherein the MFP 100 is able to perform the same processings as the input processing (Step S110) and the scanning processing (Step S170) that are performed by the FAX machine 60. In Steps S333 and S334 described above, the MFP 100 transmits an e-mail that contains the read image information, the destination information and the time limit information to the MFP 200. It should be noted that, in this system, the MFP 100 does not need to have a facsimile transmission function. It is sufficient if the MFP 100 has at least an e-mail transmission function.

(ii) A system in which image information is transmitted from the FAX machine 60, via the MFP 100, to the MFP 200, wherein the FAX machine 60 serves as the transmission apparatus, the MFP 100 serves as the relay apparatus, and the MFP 200 serves as the reception apparatus.

In this example, the FAX machine 60 performs transmission to the MFP 100 in the processing described above in Steps S110 through S200. In such a case, the operator inputs the address on the Internet 50 (e.g. a domain name) of the MFP 200 as the final destination, and such an address is taken as destination information. In such a case, no time limit information is transmitted. With this arrangement, transmission between the FAX machine 60 and the MFP 100 is performed during a time period that is before the arrival time limit and has the most inexpensive communication charge.

During the FAX reception processing performed in Step S320, the MFP 100 receives image information and destination information from the FAX machine 60. During the mail transmission processing performed in Step S330, the MFP 100 generates an e-mail to which the image information is attached and which has, as the destination, an address based on the destination information, and transmits the e-mail. It should be noted that destination information and time limit information are not attached to the e-mail.

In Step S430, the MFP 200 receives the e-mail from the MFP 100. Since destination information and time limit information are not attached to this e-mail, the judgment result in Step S413 is “NO”, and the forward request flag is not turned “ON” in Step S415. Thus, the image information does not get forwarded to any other machine. The MFP 200 has the received image information stored into the image storing unit 219, and as the other processing performed in Step S490, the MFP 200 reads the image information, as necessary, and prints out the image information.

(iii) A system in which image information is transmitted from the FAX machine 60 to the MFP 100, wherein the FAX machine 60 serves as the transmission apparatus, and the MFP 100 serves as the reception apparatus.

In this example, transmission is performed by a normal FAX transmission, not by an Internet FAX transmission. It is possible for the user at the sending end to at least save the trouble of checking for a time period that has a less expensive communication charge prior to FAX transmission.

(3) In the embodiment above, the sending end specifies an arrival time limit as a time and date according to the standard time of its location (i.e. according to the time zone at the sending end); however, since it is sufficient as long as the timing limit of arrival can be specified, the arrival time limit does not have to be expressed as a date and time. For example, it is acceptable to express the arrival time limit as a date, a day of the week, or a time. Further, it is acceptable to specify an arrival time limit as, instead of as a time or a date and time, an elapsed time from an event, for example, a point of time X hours after an image is scanned from a document, or a point of time Y hours after transmission from the sending end is performed. More specifically, for instance, when an image is read from a document at 9:00 a.m. and the operator specifies the value of “X” as “8”; then, the arrival time limit is automatically set as “5:00 p.m.”. In the similar manner, when the time of transmission if 9:00 a.m. and the operator specifies the value of “Y” as “20”; then, the arrival time limit is set as “5:00 a.m. on the following day”. The arrival time limit being set in this way will be transmitted as time limit information along with image information.

Further, it is acceptable to have an arrangement wherein, as the time limit information indicating an arrival time limit, such information is transmitted that indicates an arrival time limit being expressed as a specified length of time elapsing after the time of transmission performed by the transmission apparatus, instead of an exact time. In such a case, the relay apparatus obtains information regarding the time of transmission performed by the transmission apparatus and a specified length of time, so as to obtain an arrival time limit. For example, when image information is transmitted at 10:00 a.m., and the length of time is specified as ten hours, the relay apparatus takes 8:00 p.m. of the day as the arrival time limit so that transmission to the reception apparatus is performed during a time period that is before the arrival time limit and has the most inexpensive communication charge.

In the similar manner, it is also acceptable to have an arrangement wherein such information is transmitted to the relay apparatus that indicates an arrival time limit being expressed as a specified length of time elapsing after the time of reception of the image information. For example, the relay apparatus receives image information at 10:00 a.m. and the length of time is specified as ten hours, 8:00 p.m. of the day is taken as the arrival time limit. As additional information, as a method of notifying the relay apparatus that the arrival time limit is expressed as a length of time elapsing after the time of reception, or the like, it is acceptable to have a prearrangement within the system regarding the symbols and codes used for expressing the times and to write the symbols and codes into the FIF or the like. To be more specific, when an arrival time limit is 10 hours after the time of reception, the arrival time limit may be expressed as “time of receipt+10”, for example.

(4) Further, in the embodiment described above, a FAX gateway machine having an onramp function or an offramp function is used as the MFP; however, the present invention is not limited to this example. It is acceptable to use a copier or a FAX machine. Further, a PC (Personal Computer) onto which a program for having the computer execute the above processing is installed may act as a FAX gateway machine.

(5) A FAX machine according to the present invention is not limited to a G3 FAX machine. As long as being capable of communicating according to the facsimile transmission control procedures in compliance with G-standard as defined by the ITU-T recommendation, any FAX machine including a G4 FAX machine may be applicable. In such a case, an MFP serving as a FAX gateway also performs transmission and reception of FAX data with another FAX machine on the other end, according to the G4 facsimile procedures.

(6) Further, in the above embodiment, transmission between an onramp and an offramp is performed over a LAN and the Internet, which each have a flat-rate pricing regardless of the distances and offer more inexpensive communication charges than a telephone network that usually has a metered-rate pricing based on the distances; however, the present invention is not limited to this arrangement. It is acceptable to use WAN or an exclusive line service as a communication line other than the telephone network. In such a case, relay apparatuses may serve as the onramp and the offramp, so that FAX transmission/reception is performed with the FAX machine via the telephone line and also image information, destination information, and time limit information can be transmitted and received via the communication line.

(7) Further, in the embodiment described above, the description is provided for a case where transmission is performed in an Internet FAX mode; however, the present invention is not limited to transmission using FAX communication.

For example, it is possible to apply the present invention to an image transmission system in general in which image information is transmitted in packets, or the like. In such a system, for example, a transmission apparatus is connected to a relay apparatus via a first network, and a relay apparatus is connected to a reception apparatus via second network, and the pricing system is arranged so that the communication charges in these networks vary depending on the time periods. It is possible to achieve better effects as follows: if the first network has relatively more expensive communication charges overall than the second network, then image information is transmitted from the transmission apparatus to the relay apparatus during a time period that is before the arrival time limit and has the most inexpensive communication charge. Conversely, if the second network has relatively more expensive communication charges overall than the first network, then image information is transmitted from the relay apparatus to the reception apparatus during a time period that is before the arrival time limit and has the most inexpensive communication charge. Further, even in such cases, it is acceptable to have both the transmission apparatus and the relay apparatus perform the timer processing so that transmission is performed in the most inexpensive time period, like in the embodiment described above.

(8) In the embodiment described above, the image information and the time limit information are transmitted together from the FAX machine 60 and the MFP 100 when the facsimile transmission is performed and are transmitted as being contained in an e-mail from the MFP 100 to the MFP 200; however, it is acceptable to have an arrangement wherein the image information and the time limit information are transmitted separately (as in separate e-mails or in separate packets). In such a case the reception end of the information needs to find out to which piece of image information, the received piece of time limit information corresponds. As a method of finding that out, for example, at the sending end, an identifier is attached to each of a piece of image information and a piece of time limit information in order to indicate that these pieces of information correspond with each other. Then, the reception end refers to those identifiers attached to the piece of image information and the piece of time limit information having been received in order to find out the corresponding relation.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. An image transmission system comprising a transmission apparatus and a relay apparatus that receives image information from the transmission apparatus and forwards the image information to a reception apparatus, wherein
the transmission apparatus includes:
a receiving unit operable to receive a designation of a time limit by which the image information should arrive at the reception apparatus; and
a transmitting unit operable to transmit time limit information that indicates the time limit to the relay apparatus, and
the relay apparatus includes:
a reception unit operable to receive the time limit information transmitted from the transmitting unit;
a charge information storing unit that stores therein charge information indicating, for each of a plurality of time periods, a charge for forwarding the image information to the reception apparatus;
a determining unit operable to determine a forwarding time period during which the image information is to be forwarded to the reception apparatus, based on the time limit information and the charge information; and
a forwarding unit operable to forward the image information to the reception apparatus during the determined forwarding period.

2. The image transmission system of claim 1, wherein
the time limit information includes one of (i) a date, (ii) a day of the week, (iii) a time, which are expressed for a time zone where the transmission apparatus is located, and (iv) an elapsing time from a transmission time at which the transmission apparatus transmits the image information.

3. The image transmission system of claim 1, wherein
the determining unit determines, as the forwarding time period, a time period that is before the time limit and is advantageous in terms of the charges.

4. The image transmission system of claim 1, wherein
the transmission apparatus is connected with the relay apparatus via a communication network including the Internet,
the relay apparatus is connected with the reception apparatus via a telephone network,
the transmitting unit puts the time limit information and the image information into an Internet mail and transmits the Internet mail via the Internet,
the reception unit receives the transmitted Internet mail, and
the forwarding unit forwards, as a facsimile transmission, the image information contained in the received Internet mail to the reception apparatus via the telephone network.

5. The image transmission system of claim 1, wherein
another relay apparatus is provided between the transmission apparatus and the relay apparatus,
the transmission apparatus is connected with said another relay apparatus via a first telephone network,
said another relay apparatus is connected with the relay apparatus via a communication network including the Internet,
the relay apparatus is connected with the reception apparatus via a second telephone network,
the transmission unit transmits, as a facsimile transmission, the time limit information along with the image information to said another relay apparatus via the first telephone network,
said another relay apparatus receives, as a facsimile transmission, the transmitted image information and time limit information, puts the received image information and time limit information into an Internet mail, and transmits the Internet mail to the relay apparatus via the Internet,
the reception unit receives the Internet mail containing the image information and the time limit information from said another relay apparatus, and
the forwarding unit forwards, as a facsimile transmission, the image information contained in the received Internet mail to the reception apparatus via the second telephone network.

6. A relay apparatus that receives image information from a transmission apparatus and forwards the received image information to a reception apparatus, the relay apparatus comprising:
a reception unit operable to receive, from the transmission apparatus, time limit information that indicates a time limit by which the image information should arrive at the reception apparatus;
a charge information storing unit that stores therein charge information indicating, for each of a plurality of time periods, a charge for forwarding the image information to the reception apparatus;
a determining unit operable to determine a forwarding time period during which the image information is to be forwarded to the reception apparatus, based on the time limit information and the charge information; and
a forwarding unit operable to forward the image information to the reception apparatus during the determined forwarding period.

7. The relay apparatus of claim 6, wherein
the time limit information includes one of (i) a date, (ii) a day of the week, (iii) a time, which are expressed for a time zone where the transmission apparatus is located, and (iv) an elapsing time from a transmission time at which the transmission apparatus transmits the image information.

8. The relay apparatus of claim 6, wherein
the determining unit determines, as the forwarding time period, a time period that is before the time limit and is advantageous in terms of the charges.

9. The relay apparatus of claim 6, wherein
the transmission apparatus is connected with the relay apparatus via a communication network including the Internet,
the relay apparatus is connected with the reception apparatus via a telephone network,
the reception unit receives an Internet mail which contains the time limit information and the image information, via the Internet, and
the forwarding unit forwards, as a facsimile transmission, the image information contained in the received Internet mail to the reception apparatus via the telephone network.

10. A transmission apparatus included in an image transmission system in which image information is transmitted from the transmission apparatus to a reception apparatus via a relay apparatus, the transmission apparatus comprising:
a receiving unit operable to receive a designation of a time limit by which the image information should arrive at the reception apparatus; and
a transmitting unit operable to transmit time limit information that indicates the time limit to the relay apparatus.

11. The transmission apparatus of claim 10, wherein
the time limit information includes one of (i) a date, (ii) a day of the week, (iii) a time, which are expressed for a time zone where the transmission apparatus is located, and (iv) an elapsing time from a transmission time at which the transmission apparatus transmits the image information.

12. A transmission apparatus that transmits image information to a reception apparatus, the transmission apparatus comprising:
a receiving unit operable to receive a designation of a time limit by which the image information should arrive at the reception apparatus;
a charge information storing unit that stores therein charge information indicating, for each of a plurality of time periods, a charge for transmitting the image information;
a determining unit operable to determine a time period during which the image information is to be transmitted, based on the time limit and the charge information; and
a transmitting unit operable to transmit the image information during the determined time period.

13. The transmission apparatus of claim 12, wherein the time limit includes one of (i) a date, (ii) a day of the week, (iii) a time, which are expressed for a time zone where the transmission apparatus is located, and (iv) an elapsing time from a transmission time at which the transmission apparatus transmits the image information.

14. The transmission apparatus of claim 12, wherein
the determining unit determines, as the time period, a time period that is before the time limit and is advantageous in terms of the charges.

15. A method of transmitting image information in an image transmission system that includes a transmission apparatus, a relay apparatus that receives the image information from the transmission apparatus and forwards the received image information to a reception apparatus, wherein
the method comprises, as a processing performed by the transmission apparatus:
a receiving step of receiving a designation of a time limit by which the image information should arrive at the reception apparatus; and
a transmitting step of transmitting time limit information that indicates the time limit to the relay apparatus, and
the method further comprises, as a processing performed by the relay apparatus:
a reception step of receiving the time limit information transmitted in the transmitting step;
a determining step of determining a forwarding time period during which the image information is to be forwarded to the reception apparatus, based on the time limit information as well as charge information that indicates, for each of a plurality of time periods, a charge for forwarding the image information to the reception apparatus; and
a forwarding step of forwarding the image information to the reception apparatus during the determined forwarding period.
